(19) United States
(12) Patent Application Publication
(10) Pub. No.: US 2026/0289590 A1
(43) Pub. Date: Sep. 24, 2026

(54) SYSTEM

(71) Applicant: SoftBank Group Corp., Tokyo (JP)

(72) Inventor: Hikaru ISHIDA, Tokyo (JP)

(73) Assignee: SoftBank Group Corp., Tokyo (JP)

(21) Appl. No.: 19/558,529

(22) Filed: Mar. 6, 2026

(30) Foreign Application Priority Data
Mar. 19, 2025 (JP) 2025-044487

(51) Int. Cl. G06Q 30/0201; G06N 3/0464; G06N 3/0475

(52) U.S. Cl. CPC G06Q 30/02011; G06N 3/0464; G06N 3/0475

(57) ABSTRACT

A system includes a processor that is configured to receive input information from a user and analyze the input information to generate a prompt sentence for instructing a generative artificial intelligence model to generate a persona, input the generated prompt sentence into the generative artificial intelligence model and generate the persona by using the generative artificial intelligence model, and utilize the generated persona as a new viewpoint or opinion provider for product development.

### CROSS-REFERENCE TO RELATED APPLICATION

This application is based on and claims priority under 35 USC 119 from Japanese Patent Application No. 2025-044487 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional product development processes frequently rely on market research data such as questionnaires, interviews, and sales statistics. However, such approaches often fail to capture implicit needs, contextual behaviors, and nuanced viewpoints of potential users, and therefore do not always provide sufficient depth and breadth of insight for innovative product planning and design. In particular, existing techniques do not effectively utilize generative artificial intelligence models to construct rich, multi-dimensional personas that can act as virtual stakeholders or opinion providers in product development. Moreover, known systems lack mechanisms for systematically comparing characteristics of such personas with conventional market research data, and for dynamically adjusting product design based on persona characteristics so as to align products with evolving market needs. Accordingly, there is a need for a system that can automatically generate personas using a generative artificial intelligence model based on user input, leverage these personas as new viewpoints or opinion providers, compare persona characteristics with market research data to obtain deeper and broader insights, and support product design adjustments that reflect actual market demands.

### SUMMARY

To solve the above-described problems, an aspect of the invention provides a system comprising a processor, wherein the processor is configured to receive input information from a user and analyze the input information to generate a prompt sentence for instructing a generative artificial intelligence model to generate a persona, input the generated prompt sentence into the generative artificial intelligence model and generate the persona by using the generative artificial intelligence model, and utilize the generated persona as a new viewpoint or opinion provider for product development. The processor is further configured to compare market research data with characteristics of the generated persona and provide a depth and breadth of insight that are not obtainable by general market research. Additionally, the processor is configured to adjust product design based on characteristics of the generated persona and support product development in accordance with market needs.

The term “system” refers to a combination of hardware and software components, including at least one processor, configured to execute the functions recited in the claims.

The term “processor” refers to one or more hardware processing units, such as a central processing unit (CPU), graphics processing unit (GPU), or dedicated accelerator, that execute instructions to perform the operations described in the claims.

The term “user” refers to a human operator or entity that provides input information to the system for the purpose of generating a persona and supporting product development.

The term “input information” refers to data, including but not limited to text, parameters, or settings, that is provided by the user and that is analyzed by the processor to generate a prompt sentence.

The term “analyze” refers to processing input information using predetermined rules, algorithms, or models to extract, interpret, or transform content necessary for subsequent operations, such as generating a prompt sentence.

The term “prompt sentence” refers to a textual or structured instruction generated by the processor and provided to a generative artificial intelligence model to cause the model to generate a persona in accordance with specified conditions.

The term “generative artificial intelligence model” refers to a machine learning model, such as a large language model or other generative model, that is capable of producing new content, including textual descriptions of personas, in response to input prompts.

The term “persona” refers to a virtual, fictitious, or representative user profile that includes characteristics such as demographics, preferences, behaviors, needs, and opinions, and that is generated by the generative artificial intelligence model based on the prompt sentence.

The term “characteristics of the generated persona” refers to attributes, parameters, or descriptive elements associated with a persona, including, for example, age, occupation, lifestyle, goals, pain points, purchasing behavior, and expressed opinions.

The term “product development” refers to activities related to the planning, design, improvement, and evaluation of products or services, including concept creation, specification design, and feature prioritization.

The term “new viewpoint or opinion provider” refers to the role of the persona as a virtual stakeholder that provides alternative perspectives, comments, or feedback to be considered in product development, beyond those obtained from existing market research.

The term “market research data” refers to information obtained from market surveys, interviews, usage statistics, sales records, or other empirical investigations of actual or potential users in the market.

The term “compare” refers to processing operations in which market research data is evaluated against characteristics of the generated persona, including identifying similarities, differences, correlations, or gaps.

The term “depth and breadth” refers to the qualitative richness (depth) and the variety or coverage (breadth) of insights, perspectives, or hypotheses obtained by combining persona characteristics with market research data.

The term “product design” refers to the specification and configuration of a product or service, including functions, features, user interface, performance targets, and other design parameters.

The term “adjust product design” refers to modifying, refining, or reconfiguring elements of product design based on characteristics of the generated persona, such as changing features, priorities, or target user scenarios.

The term “market needs” refers to expectations, demands, problems, and preferences of users or customers in a target market, as inferred from market research data, persona characteristics, or a combination thereof.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

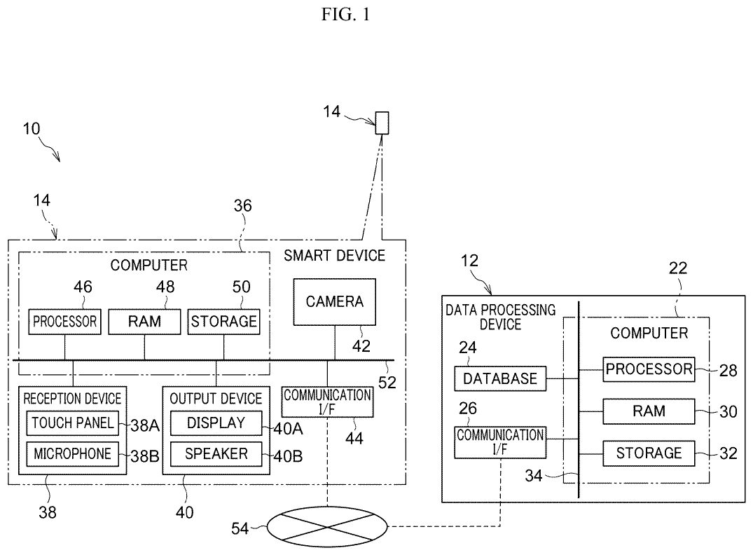

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

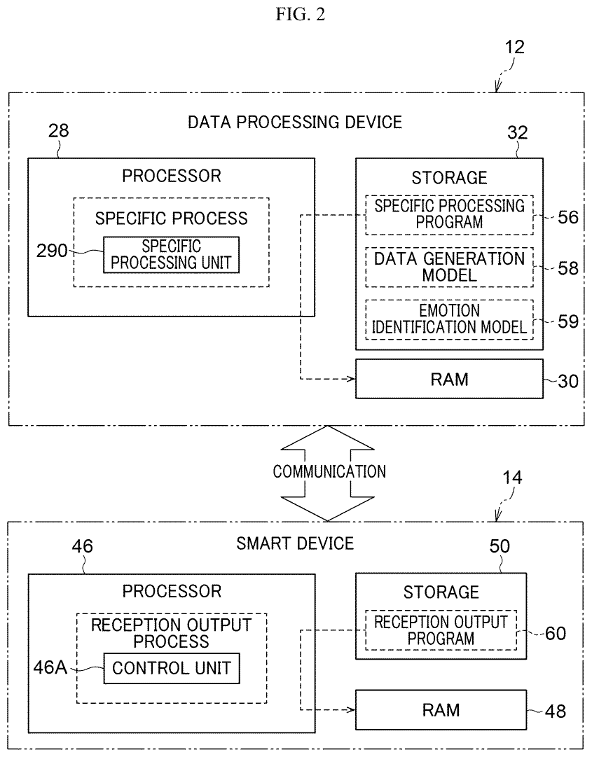

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented recommendation systems that run on general-purpose hardware and software typically rely on fixed rule sets, manually curated keyword mappings, or shallow statistical models to interpret user input and propose product candidates. When a user enters free-form text describing a hobby they wish to start, such as a new leisure activity or interest, existing systems often perform only surface-level keyword extraction and direct string matching against a product catalog. As a result, these systems fail to accurately infer nuanced user requirements, user context, or latent preferences associated with the described hobby, and therefore generate product lists that are either incomplete, irrelevant, or poorly prioritized.

Furthermore, in standard architectures, the generation of user profiles and product recommendations is decoupled from deeper behavioral or requirement modeling. Processors in such systems generally do not leverage advanced text generation technologies to synthesize a rich, structured virtual profile that can function as a proxy “user” for evaluation and refinement of recommendation logic. Consequently, it is difficult for the computing system to produce recommendations that go beyond what is directly observable from the input text, and it is also difficult to systematically adapt recommendation results to evolving market trends or survey data using the same computational pipeline.

In addition, conventional systems typically handle hobby-related product retrieval as a one-step query against a database, without an intermediate reasoning stage in which a virtual person is generated and used as a computational construct to derive requirement information. This lack of an intermediate representation limits the system's ability to expand, refine, and rank candidate products in a way that reflects realistic user behavior and expert-like advice. From a computer technology standpoint, this leads to underutilization of available processing resources and learning models, and results in a rigid and brittle recommendation pipeline.

Moreover, existing server-side implementations often do not integrate generative AI models in a manner that programmatically constructs and uses prompt sentences as first-class data structures within the processing flow. Without explicit prompt generation logic that is dynamically tailored to the user's hobby description and requirement information, the processor cannot fully exploit the generative capabilities of the model to create virtual persons that encapsulate consistent and reproducible preference profiles. This limits the effectiveness, robustness, and extensibility of the system.

Therefore, there is a need for an improved computer-implemented system in which a processor can (i) receive and analyze user input related to a hobby, (ii) automatically generate and submit structured prompt sentences to a generative AI model to synthesize a virtual person representing a user profile, (iii) use both the original input and the virtual person to create search information for retrieving and organizing candidate product groups, and (iv) provide a structured product list to a user terminal in a form that directly supports efficient purchase actions and can be evaluated and refined against market data. Such a system should improve the technical functionality of the server-side recommendation engine and enhance the quality, depth, and adaptability of generated recommendations in a scalable and machine-implementable way.

The specific processing by the specific processing unit 290 of the data processing device 12 in Example 1 is realized by the following means.

The present invention provides a server comprising a processor and a memory storing instructions that, when executed by the processor, cause the processor to receive input information related to a hobby from a user terminal, analyze the input information to extract a user profile and requirement information related to the hobby, generate a prompt sentence configured to cause a generative AI model to generate the user profile based on the extracted user profile and requirement information, transmit the prompt sentence to the generative AI model and obtain information of a virtual person corresponding to the user profile from the generative AI model, generate search information for extracting candidate product groups required for an activity related to the hobby by using the input information and the information of the virtual person, retrieve the candidate product groups from a storage device based on the search information, generate list information of the candidate product groups, and transmit the list information to the user terminal together with purchase information for each product included in the list information. This enables the server to implement an improved computer-implemented recommendation pipeline in which dynamically generated prompt sentences and virtual persons are used as internal computational artifacts to refine search information, expand and organize candidate product groups, and deliver more accurate and context-aware product lists to the user terminal, thereby enhancing the technical performance, flexibility, and recommendation quality of the underlying processing system.

The term “processor” refers to a hardware-based information processing element, such as a central processing unit or a computing core, that executes instructions to perform data reception, analysis, prompt generation, model invocation, search processing, and communication control in the system.

The term “memory” refers to a hardware-based storage medium, such as a volatile or non-volatile storage device, that stores instructions and data to be executed and processed by the processor in order to implement the functions of the system.

The term “input information” refers to digital data representing at least one character string or symbol sequence received from a user, the digital data describing a hobby or activity that the user wishes to start or pursue.

The term “hobby” refers to an activity or field of interest voluntarily selected by a user for leisure, self-improvement, or entertainment, including but not limited to sports, arts, crafts, games, and other non-professional activities.

The term “user profile” refers to a set of attribute information derived from input information, the attribute information representing characteristics, preferences, or behavioral tendencies of a user with respect to a hobby.

The term “requirement information” refers to structured or semi-structured data that represents needs, constraints, or expectations of a user related to a hobby, the data being generated by analyzing the input information and optionally by further processing output of a generative AI model.

The term “prompt sentence” refers to a text sequence or instruction string generated by the processor and supplied as input to a generative AI model, the text sequence specifying a task, context, or output format required from the generative AI model.

The term “generative AI model” refers to a machine learning model, such as a neural network-based language model, configured to generate text or structured data in response to an input prompt sentence, based on parameters obtained through prior training on data sets.

The term “virtual person” refers to an artificial profile or agent representation generated by the generative AI model in response to a prompt sentence, the artificial profile including characteristics, preferences, and viewpoints that simulate a hypothetical or representative user.

The term “information of the virtual person” refers to data describing attributes, opinions, or inferred needs of the virtual person, the data being output by the generative AI model and used by the processor as an internal representation to guide subsequent processing.

The term “search information” refers to data derived from at least the input information and the information of the virtual person, the data including search keys, category identifiers, or query parameters used by the processor to retrieve candidate product groups from a storage device.

The term “candidate product group” refers to one or more product records retrieved based on the search information, each product record being associated with a hobby-related item that may be suitable for use in an activity related to the hobby.

The term “list information of the candidate product groups” refers to structured data representing an organized collection of candidate product groups, including identifiers, names, attributes, and purchase information of products, formatted for presentation to a user terminal.

The term “storage device” refers to a hardware-based data storage apparatus, such as a database system or file system, that stores product information, market information, or other related data used by the processor when generating and retrieving candidate product groups.

The term “user terminal” refers to an information processing apparatus operated by a user, such as a client device or communication terminal, that is configured to transmit input information to the server and display list information and purchase information received from the server.

The term “purchase information” refers to data associated with a product, including at least a link, identifier, or reference usable for initiating a purchase process, and optionally including price information, availability information, or access information to a purchase processing screen.

The term “market trend information” refers to data representing tendencies, changes, or distributions in a market over time, such as sales statistics, category growth indicators, or popularity metrics related to products or hobbies.

The term “survey information” refers to data obtained from investigations or questionnaires conducted on a group of subjects, the data including responses, ratings, or comments related to products, hobbies, or user preferences.

The term “depth and diversity of requirements” refers to the extent and variety of user needs identified by the processor, including not only explicit requirements contained in the input information but also implicit or derived requirements inferred through comparison with market trend information or survey information.

The term “product configuration” refers to a structure or combination of one or more products or product options that are proposed as a set for an activity related to a hobby, the structure being adjustable based on characteristics of a virtual person and list information.

The term “product specification” refers to technical or descriptive information defining a property, function, or performance aspect of a product, the information being subject to adjustment in response to requirement information and characteristics of a virtual person.

The term “product planning” refers to a process in which new products, product sets, or product variations are conceptualized and designed, using information derived from the virtual person and candidate product groups to align with user needs related to a hobby.

The term “product design” refers to a process in which detailed structural, functional, or aesthetic features of a product are determined, refined, or modified, based at least in part on characteristics of the virtual person and the list information of the candidate product groups.

The server includes at least one processor, a memory, a communication interface, and a storage device implemented on general-purpose or specialized hardware. The server executes an operating system such as a UNIX-type system or a similar multi-tasking operating system, and application software implemented, for example, using a server-side framework such as a script-based framework or an interpreter-based framework. The server communicates with a terminal operated by a user via a network using a standard communication protocol such as HTTPS over TCP/IP.

The terminal includes a processor, a memory, a display, an input interface, and a network interface. The terminal executes a web browser or a native application that provides a graphical user interface implemented, for example, using HTML5, CSS, and JavaScript. The terminal displays input fields for hobby-related information and renders product list information received from the server. The user operates the terminal by inputting hobby-related text and selecting displayed products.

The server stores in the memory and the storage device program modules including: a reception module, an analysis module, a prompt generation module, a generative AI interface module, a virtual person processing module, a search information generation module, a product retrieval module, a list generation module, a transmission module, and an optional market comparison module and design support module. Each module is realized as instructions executed by the processor, and the modules may be implemented as separate processes or as logically separated components within a single application.

The server uses a storage device implementing a structured data management system such as a relational database system or a search-oriented data store. The storage device stores product data records, each record including at least a product identifier, a category identifier, a textual description, a set of attributes (for example, size, material, usage level), a price, an availability flag, and purchase-related link information. The storage device further stores market trend data and survey data, which may be aggregated statistics and user response records, and stores logs of user inputs, generated prompt sentences, virtual person information, and search information.

The server acquires, from the terminal, digital input information representing a hobby that the user wishes to start or pursue. The input information is represented as a character string encoded in a character encoding such as UTF-8 and transmitted in a structured data format such as a serialized object. The server stores the received input information along with a timestamp and a user identifier in the storage device. The server performs text normalization processing on the input information, including Unicode normalization, whitespace normalization, and optional language detection by applying probabilistic language classification based on n-gram statistics or a lightweight classifier.

The server executes the analysis module to derive a user profile and requirement information related to the hobby from the normalized input text. The server uses a natural language processing library or an in-house text analysis module to perform tokenization, part-of-speech tagging, and named entity recognition. The server may compute numerical feature vectors for the text using methods such as word embeddings or term-frequency-inverse-document-frequency. The server uses these features to identify terms describing the hobby domain (for example, “golf”, “photography”), usage level (for example, “beginner”, “advanced”), constraints (for example, “indoor”, “low budget”), and purpose (for example, “health”, “professional improvement”). The server stores the derived user profile and requirement information as structured data in the storage device.

The server uses the prompt generation module to construct a prompt sentence that is supplied to a generative AI model. The server assembles the prompt sentence from a template and dynamic content derived from the user profile and requirement information. The server may control the length and structure of the prompt sentence according to configuration rules stored in the storage device. The prompt sentence is a natural language string that describes a task to the generative AI model, specifies the context, and specifies an expected output style. For example, the server may generate a prompt sentence as follows:

“The user wants to start a new hobby and entered the following sentence: ‘I want to start playing golf as a hobby’.

Identify the main hobby and describe a detailed virtual person who is a beginner in this hobby, including age range, experience level, typical constraints, and typical needs.

Based on this virtual person, list the essential and recommended products that this virtual person would need to purchase to start this hobby effectively.”

The server may alternatively generate a prompt sentence such as:

“The user wrote: ‘I want to start photography as a hobby’.

Act as a virtual person who represents a typical beginner in photography.

Describe your characteristics and then list the main product categories and specific items you would consider essential to start this hobby.”

The generative AI model is implemented as a neural network-based language model deployed on specialized hardware such as graphics processing units or tensor processing units. The generative AI model may use a transformer architecture including multiple layers of self-attention and feedforward sub-layers. The server accesses the generative AI model via an application programming interface provided by a model-serving system. The generative AI interface module of the server serializes the prompt sentence, sets model parameters such as temperature, maximum output length, and sampling strategy, and transmits the request to the model-serving system over a secure network connection.

The server, upon receiving an output sequence from the generative AI model, interprets the output as information of a virtual person and associated product-related expressions. The virtual person information may include attributes such as a descriptive age range, lifestyle, time availability, budget constraints, skill level, and specific hobby-related preferences. The server applies parsing rules and pattern matching to the generated text to extract structured fields. For example, the server may search for predefined keywords such as “I would buy”, “essential”, “recommended”, and extract text segments following these markers as candidate product descriptors. The server stores the structured virtual person information and product descriptors in the storage device.

The generative AI model is previously trained on large-scale text corpora using supervised and unsupervised learning methods. During training, the model parameters, such as weight matrices of the attention layers and feedforward layers, are updated by backpropagation, using an error function such as cross-entropy between predicted token distributions and reference tokens. The generative AI model is configured as a sequence-to-sequence predictor that outputs next-token probabilities conditioned on the prompt sentence. The server does not retrain the generative AI model during normal operation, but the server may adapt prompt templates and parsing rules based on logged outcomes. The internal architecture of the model, including attention heads, layer normalization, and positional encoding, enables the model to capture long-range dependencies in the prompt sentence and generate coherent virtual person descriptions that cannot be easily obtained by simple rule-based systems.

The server uses the search information generation module to create search information from the input information and the virtual person information. The search information is represented as a structured data object including at least: a list of product-related keywords, one or more category identifiers, importance weights assigned to each keyword or category, and constraints such as budget range and beginner/advanced level. The server constructs this data object by combining explicit terms extracted from the input text with implicit needs inferred from the virtual person's attributes. For example, when the hobby is golf and the virtual person is described as a beginner with limited budget and limited time, the server assigns higher weights to basic equipment such as “beginner golf club set”, “practice balls”, and “lightweight golf bag”, while down-weighting luxury items.

The server provides the search information to the product retrieval module, which communicates with the storage device implementing a product catalog. The server formulates structured queries that incorporate the weighted keywords, category identifiers, and constraints. When a relational database is used, the server generates parameterized statements that filter records by category and apply similarity ranking using functions that compute text similarity metrics or precomputed embedding distances. When a search engine is used, the server constructs query objects specifying term boosting factors and filters. The server retrieves candidate product records representing physical goods related to the hobby.

The server further processes the retrieved product records by applying ranking and grouping algorithms. The server may compute a relevance score for each product based on a combination of the keyword weights from the search information, product popularity metrics stored in the storage device, and compatibility with the virtual person's attributes. For example, the server may penalize products exceeding the virtual person's inferred budget threshold or products labeled as “advanced” when the virtual person is a beginner. The server groups the products into logical categories such as “essential items”, “optional accessories”, and “advanced upgrades”. The server constructs list information of the candidate product groups, comprising structured data that associates each product with a category, a rank, and purchase information including at least a purchase link and a display price.

The server transmits the list information to the terminal. The terminal receives the list information, decodes it, and uses a rendering engine of the browser or application to generate a structured layout. The terminal displays product group sections and product cards containing names, descriptions, images, and selectable purchase elements. The user views the display, and when the user selects a purchase element, the terminal opens a purchase processing screen or an external site associated with the purchase link. In some embodiments, the terminal may send back to the server signals representing user interactions such as clicks, dwell time, or scrolling behavior. The server can then use these signals to adjust future weighting rules or prompt templates, thereby continuously improving recommendation quality.

The server may optionally use a market comparison module to compare the requirement information and virtual person characteristics with market trend data and survey information stored in the storage device. The server maps requirement attributes to market indices, such as the relative popularity of certain product types among beginners in a given hobby. The server analytically determines which predicted needs are under-served or over-served by existing products by computing differences between virtual person-derived demand indicators and observed market supply indicators. This comparison is performed using algorithmic rules, such as difference thresholds or correlation analysis, and does not simply replicate human reasoning. The server thereby identifies candidate areas for product adjustments or new product planning.

The server may further execute a design support module that uses virtual person characteristics and list information of candidate product groups to propose changes in product configuration or product specification. For example, the server may aggregate feedback from multiple virtual persons and identify that certain combinations of attributes (such as lighter weight and smaller size for a golf bag) are consistently preferred for beginner golfers with limited physical strength. The server outputs configuration recommendations as structured data, which can be integrated into a product design workflow. This process improves the technical operation of computer-based design tools, because the server supplies machine-derived, structured requirement data that has been synthesized using a high-capacity generative model and specialized parsing logic.

The described configuration provides technical effects beyond mere automation of human tasks. The server generates and uses prompt sentences as explicit data structures to control the behavior of a transformer-based generative AI model. The server converts free-form input text into structured internal representations (user profile, requirement information, virtual person information, search information) using non-trivial algorithms. These internal representations enable the server to perform efficient search over large product catalogs with reduced query complexity and improved accuracy, thereby reducing the number of database accesses and network transfers required to obtain relevant results. Because the server automatically tailors the prompt sentence and parses the generative output to construct high-quality search information, the system improves retrieval precision compared with conventional keyword-based methods, which in turn reduces the need for repeated queries and interactive corrections.

Moreover, the server's use of attention-based language modeling enables extraction of latent needs that are not explicitly present in the input text. By systematically encoding and weighting these latent needs in the search information, the server creates a refined search space that is not obtainable by straightforward human inspection or simple rules. This leads to improved ranking quality, manifested as higher probability that products shown at higher positions in the list are actually selected or purchased. The reduction in irrelevant results and unnecessary data transmission also contributes to reduced communication load between the server and the terminal.

The generative AI model used by the server employs a multi-layer transformer architecture with a plurality of attention heads, layer normalization, and position-wise feedforward networks. During training, the model uses mini-batch gradient descent and an error function such as token-level cross-entropy, and updates weights by a variant of gradient-based optimization. The server, when invoking this model at runtime, configures sampling parameters (for example, temperature and top-k or top-p sampling) to balance determinism and diversity, and thereby controls the stability of the virtual person output. The server's prompt generation and parsing algorithms are designed specifically to exploit these architectural characteristics by providing well-structured instructions and expecting predictable output sections that can be reliably parsed.

The system thus implements an improvement in computer technology itself. The server changes the way a recommendation engine is architected by (i) inserting a generative modeling stage controlled by dynamically generated prompt sentences, (ii) using a virtual person representation as an internal object to derive and weight search information, and (iii) integrating market comparison and design support functions into the same computational framework. This configuration achieves higher recommendation accuracy, better alignment with actual user needs, and more efficient use of storage and network resources, in a way that is not conventionally achievable by simple rule-based or non-generative systems.

In alternative embodiments, the server may use different neural network models such as encoder-decoder architectures, recurrent networks, or hybrid models, provided that the models accept prompt sentences and generate text representing virtual persons and product-related content. The server may also vary the feature extraction methods; for example, the server may use character-level embeddings for languages with complex scripts, or may integrate part-of-speech patterns as explicit features in the analysis module. The search information generation module may employ different weighting schemes, such as learned ranking functions trained on historical interaction logs. The storage device may be implemented as a distributed storage system, and the product retrieval module may operate across multiple shards or indices.

In another embodiment, the server may execute the generative AI model locally, using dedicated hardware accelerators. In such a configuration, the server may implement runtime fine-tuning procedures in which the generative AI model is periodically updated using domain-specific training data such as hobby-related product descriptions and user feedback logs. The server may modify internal weights by minimizing a domain-specific loss function, for example, a combination of language modeling loss and recommendation accuracy loss. This configuration further improves adaptation to particular hobby domains and maintains the technical advantages of the system.

In yet another embodiment, the terminal may perform part of the analysis processing, such as lightweight keyword extraction or preliminary language detection, before sending the data to the server, thereby reducing the amount of data transmitted and the processing load on the server. The server still performs the core prompt generation, generative AI invocation, and product retrieval. This division of labor can reduce end-to-end latency and improve responsiveness from the perspective of the user.

Through these various embodiments, the server, the terminal, and the generative AI model cooperate as a technical system that processes digital data in specific, non-conventional ways, achieves improved computational efficiency and accuracy, and produces structured outputs that can be used directly for real-world product selection and design support.

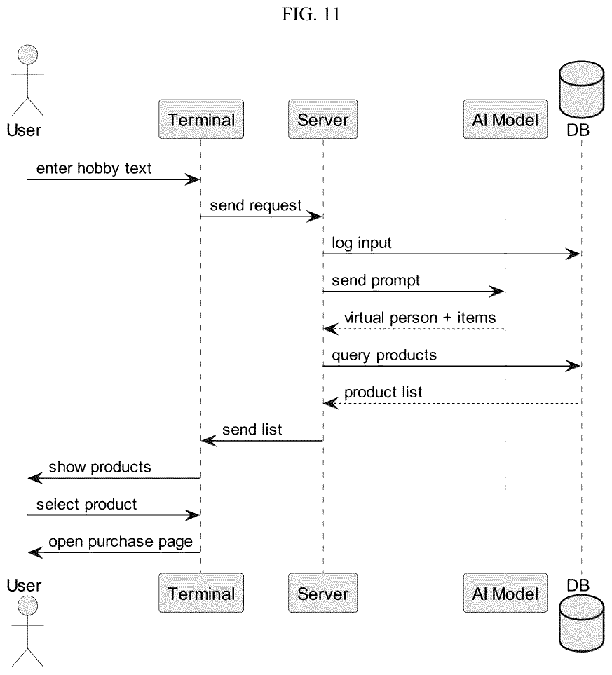

The following describes the processing flow using FIG. 11.

### Step 1

The terminal displays a hobby input screen to the user.

The terminal allocates an input field, a submit button, and optional guidance text on a display area using a browser rendering engine.

The user inputs hobby-related text, such as “I want to start playing golf as a hobby,” into the input field and operates the submit button.

Input: User's raw hobby sentence entered through the input interface.

Output: A character string held in the terminal's memory representing the hobby description.

### Step 2

The terminal performs basic validation and packaging of the input.

The terminal checks that the character string is not empty and that its length is within a predetermined range, and removes leading and trailing whitespace.

The terminal then creates a structured data object including at least a user identifier, a timestamp, and the normalized hobby text.

Input: Raw hobby text and metadata (user identifier, local time).

Output: A structured request object ready for transmission to the server.

### Step 3

The terminal transmits the structured request object to the server.

The terminal encodes the object in a serialized format and sends it to a predefined API endpoint of the server using HTTPS.

The terminal stores the request identifier locally if available to correlate the request and response.

Input: Structured request object containing the user's hobby text.

Output: A network message containing the structured request delivered to the server.

### Step 4

The server receives and stores the request.

The server accepts the HTTPS request via a communication interface, decodes the serialized body, and extracts the user identifier, timestamp, and hobby text.

The server then writes a log record into a storage device, associating the request with a server-side timestamp and a generated internal request identifier.

Input: Network message containing the structured request.

Output: Parsed request data in server memory and a persistent log entry including the internal request identifier.

### Step 5

The server normalizes and analyzes the hobby text.

The server applies text normalization operations such as Unicode normalization, lowercasing (where appropriate), and whitespace compression.

The server tokenizes the text into tokens, may apply part-of-speech tagging, and extracts candidate domain terms and modifiers related to hobby type, level, constraints, and purposes.

Input: Parsed raw hobby text string from the request.

Output: Normalized text string and intermediate linguistic features (tokens, tags, candidate terms) stored in memory.

### Step 6

The server derives a user profile and requirement information.

The server groups the extracted candidate terms into profile attributes (for example, “beginner,” “outdoor activity”) and requirement attributes (for example, “needs basic equipment,” “limited budget”) using rule-based mappings or learned classification thresholds.

The server constructs a user profile object and a requirement information object as structured data, and stores them in the storage device linked to the internal request identifier.

Input: Linguistic features and normalized text from Step 5.

Output: User profile object and requirement information object representing structured needs for the hobby.

### Step 7

The server generates a prompt sentence for a generative AI model.

The server selects a template according to a hobby type or language, inserts fields from the user profile and requirement information into the template, and forms a coherent natural language instruction.

The server may append explicit instructions about output structure and content, such as requesting description of a virtual person and a product list.

Input: User profile and requirement information objects.

Output: A synthesized prompt sentence string configured to guide the generative AI model.

### Step 8

The server calls the generative AI model with the prompt sentence.

The server passes the prompt sentence and model parameters (for example, temperature and maximum token count) to a model-serving interface via a network or local procedure call.

The server waits for the model to generate an output sequence and receives the generated text, which describes a virtual person and related product suggestions.

Input: Prompt sentence string and model configuration parameters.

Output: Generated text sequence that contains virtual person information and candidate product descriptions.

### Step 9

The server parses the generative AI model output into structured virtual person information.

The server analyzes the generated text, locates segments that describe attributes such as age range, experience level, budget, and preference, and maps these segments onto predefined attribute fields.

The server also extracts text fragments that correspond to product names or categories by scanning for patterns such as enumerated lists or phrases following markers like “essential items” or “recommended products.”

Input: Generated text sequence from the generative AI model.

Output: Virtual person information object and a preliminary list of product descriptors.

### Step 10

The server generates search information from the input information and virtual person information.

The server combines explicit terms from the user's normalized hobby text, the requirement information, and the product descriptors provided by the virtual person into a unified set of search terms.

The server assigns weights to each term based on relevance to beginner needs, budget sensitivity, and usage frequency derived from the virtual person attributes, and forms a search information object including weighted terms, category identifiers, and constraints.

Input: User profile, requirement information, and virtual person information including product descriptors.

Output: Search information object containing weighted keywords, categories, and constraints for product retrieval.

### Step 11

The server retrieves candidate product groups from the storage device.

The server translates the search information into one or more database or search engine queries, inserting weighted terms and constraints into query clauses or ranking functions.

The server executes the queries, obtains product records that match the specified conditions, and assigns initial relevance scores based on query results and stored popularity metrics.

Input: Search information object from Step 10.

Output: A set of candidate product records representing potential items for the hobby.

### Step 12

The server ranks and groups the candidate products into list information.

The server calculates final ranking scores for each product by combining search-based similarity scores, weight factors from the search information, and compatibility with the virtual person's attributes.

The server groups products into logical categories such as essential items, optional accessories, and advanced upgrades, and constructs list information that organizes products by category, sorted by rank, and includes purchase information fields.

Input: Candidate product records and search information with weights and constraints.

Output: List information of candidate product groups, structured for presentation at the terminal.

### Step 13

The server transmits the list information to the terminal.

The server serializes the list information into a response message, sets response metadata such as content type and success status, and sends the message back to the terminal via HTTPS.

The server logs the response size, number of products included, and processing time associated with the internal request identifier.

Input: List information data structure generated in Step 12.

Output: A network response message containing the structured product list delivered to the terminal.

### Step 14

The terminal receives and renders the list information.

The terminal decodes the response message, reconstructs the list information data structure, and generates user interface elements such as sections and product cards based on the categories and product attributes.

The terminal associates each product card with a selectable purchase element using the purchase information (for example, a URL) and arranges the cards on the display.

Input: Network response message containing the list information.

Output: A rendered product list interface displayed to the user, with interactive purchase controls.

### Step 15

The user interacts with the displayed product list.

The user scrolls through the list and visually evaluates products using the terminal's display, then selects a desired product by activating the corresponding purchase element.

Input: Visual representation of categorized product cards on the terminal's display.

Output: A user interaction event (such as a click or tap) targeting a specific product's purchase element.

### Step 16

The terminal initiates access to a purchase processing resource.

The terminal processes the user interaction event, extracts the purchase link or identifier from the selected product's purchase information, and either opens an external purchase page in a browser context or sends a request to a purchase processing system.

The terminal may transmit selection information back to the server as feedback, including the product identifier and associated request identifier.

Input: User interaction event selecting a product and the purchase information linked to that product.

Output: A navigation action to a purchase screen or external system, and optionally a feedback message to the server indicating the selected product.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented recommendation systems for consumer articles typically rely on predefined rule sets, manually curated lists, or simple keyword matching against product catalogs. Such systems are limited in their ability to understand free-form, natural language descriptions of a user's intended hobby or leisure activity, and therefore often generate recommendations that are either overly generic or incomplete. As a result, users must perform multiple search iterations and manually aggregate information from various sources, which leads to increased interaction latency, higher cognitive load, and an overall degraded user experience.

In particular, when a user wishes to start a new hobby, the user's input is often expressed as an abstract, high-level intention (for example, “I want to start photography” or “I want to start road cycling”), rather than as a concrete list of products. Traditional systems are not architected to computationally transform such high-level intentions into a structured, machine-usable set of item candidates. They lack an integrated mechanism to (i) construct context-appropriate instructions for a generative AI model, (ii) convert the model's unstructured natural language output into a normalized, structured article list, and (iii) automatically enrich that list with purchase-related attributes suitable for immediate presentation and transaction support on heterogeneous user terminals.

Furthermore, existing architectures that do integrate generative AI models often treat prompt construction and response handling as ad hoc application logic. They do not provide a systematic, processor-level configuration that dynamically adapts prompt sentences and output formats based on user attributes, context conditions, and device capabilities. This results in inefficient use of computational resources, increased network traffic due to redundant requests, and inconsistent recommendation quality across different usage scenarios.

Accordingly, there is a need for an improved computer-implemented system and processing architecture that: (i) efficiently transforms user intent regarding hobbies or leisure activities, expressed in natural language, into a prompt sentence suitable for a generative AI model; (ii) reliably converts unstructured output from the generative AI model into structured article list information with standardized fields; and (iii) enriches and delivers this information to user terminals in a format optimized for immediate, low-friction consumption and purchasing actions. Such an architecture should improve the technical performance of the recommendation pipeline as a whole, including reduced server-side processing complexity, reduced need for repeated user interactions, and more efficient mapping between natural language input and transactional data structures.

The specific processing by the specific processing unit 290 of the data processing device 12 in Application Example 1 is realized by the following means.

The present invention provides a server comprising a processor configured to receive, from a user terminal, input information related to a user's hobby or leisure activity, analyze the input information, and generate a prompt sentence that instructs a generative AI model to enumerate a group of articles necessary for starting the hobby or leisure activity; to input the generated prompt sentence into the generative AI model and, by using the generative AI model, generate article list information including a plurality of articles related to the hobby or leisure activity; to convert the generated article list information into structured data by assigning, for each article, at least an identifier, description information, and acquisition-source information so as to generate output data; to refer, for each article included in the generated article list information, to at least one of an article information storage device and an external article information providing device to acquire at least one of price information, image information, and purchase-link information and add the acquired information to the output data; and to dynamically modify at least one of a wording format of the prompt sentence, an output format of the article list information, and an upper limit on a number of articles based on at least one of content of the input information, user attribute information, and preset condition information, and to transmit the output data to a mobile information terminal via a communication line so that the mobile information terminal visually presents the output data to a user. This enables a computer-implemented recommendation pipeline in which natural language intent regarding hobbies or leisure activities is efficiently transformed into optimized prompt sentences and, in turn, into enriched, structured article lists, thereby improving the technical performance of the server-side processing, reducing user interaction overhead, and providing terminal-ready data that directly supports article selection and purchase actions.

The term “system” refers to a combination of one or more hardware devices and one or more software components that cooperate to execute the functions described in the claims.

The term “processor” refers to one or more hardware processing units, such as a central processing unit, a microprocessor, or a processing core, that execute machine-readable instructions to perform the claimed operations.

The term “user terminal” refers to an information processing device operated by a user, such as a mobile information terminal, a portable communication device, or a general-purpose computing device, that transmits input information to the system and receives output data from the system.

The term “mobile information terminal” refers to a portable electronic device having communication capability and a display unit, such as a smartphone, a tablet device, or a handheld computing device, that is configured to visually present information to a user.

The term “input information” refers to data received from the user terminal that represents a user's intention, requirement, or condition, including at least natural language text describing a hobby or leisure activity that the user intends to start.

The term “hobby or leisure activity” refers to a non-professional activity that a user voluntarily performs for enjoyment, learning, or personal development, such as photography, cycling, cooking, or similar pursuits.

The term “prompt sentence” refers to a sequence of one or more characters, words, or phrases, typically expressed in natural language, that is generated by the processor and provided as an instruction input to a generative AI model in order to cause the model to output desired information.

The term “generative AI model” refers to a machine-learned model, such as a neural network-based language model, that receives a prompt sentence as input and generates new data, including natural language text, based on statistical patterns learned from training data.

The term “article list information” refers to information that includes a plurality of records, each record representing an article related to the hobby or leisure activity, and that is generated by the generative AI model in response to the prompt sentence.

The term “article” refers to a tangible or intangible item that is usable by the user in connection with the hobby or leisure activity, such as equipment, tools, accessories, or consumable goods.

The term “structured data” refers to data organized according to a defined schema or data model, in which each article is represented by a set of fields, such as an identifier, description information, and acquisition-source information, that are suitable for processing by computer programs.

The term “identifier” refers to data that uniquely or distinctively identifies an article within a data set, such as an alphanumeric code, a record key, or another distinguishing label.

The term “description information” refers to text or other data that explains characteristics, usage, or features of an article, including at least a name of the article and an explanation of its relevance to the hobby or leisure activity.

The term “acquisition-source information” refers to data that indicates a source from which an article can be obtained, including at least information enabling access to a seller, provider, or other supply source of the article.

The term “output data” refers to data generated by the processor from the article list information and associated information, formatted in a structured manner that is suitable for transmission to and presentation on the user terminal or mobile information terminal.

The term “communication line” refers to a wired or wireless communication medium, such as the Internet, a local area network, or a cellular communication network, over which data is transmitted between the system and the user terminal or mobile information terminal.

The term “merchandise information storage device” refers to a storage apparatus or storage subsystem, such as a database system or file storage system, that stores information related to articles, including at least price information, image information, and purchase-link information.

The term “external merchandise information providing device” refers to an external server, service, or information system accessible via the communication line that provides merchandise-related information for articles, such as catalog information, pricing, images, and purchase links.

The term “price information” refers to data indicating a monetary amount or range associated with the purchase or acquisition of an article.

The term “image information” refers to data representing a visual depiction of an article, such as a digital image file, an image URL, or metadata suitable for rendering the article's image on a display.

The term “purchase-link information” refers to data that specifies a resource locator or similar connection information, such as a network address or uniform resource locator, that enables a user to access a purchase page or transaction interface for an article.

The term “user attribute information” refers to data associated with a user, such as demographic information, preference information, past behavior information, or device-related information, that can be used to customize processing performed by the processor.

The term “preset condition information” refers to configuration data or rules defined in advance by a system administrator, service provider, or application, which specify conditions or constraints used by the processor when generating prompt sentences or article list information.

The term “wording format of the prompt sentence” refers to structural and stylistic aspects of the prompt sentence, including language, sentence pattern, requested output style, and explicit instructions provided to the generative AI model.

The term “output format of the article list information” refers to a layout, structure, or representation style used for the article list information, including ordering of items, inclusion of specific fields, and formatting conventions applied to the data.

The term “upper limit on a number of articles” refers to a maximum number of article entries that the processor instructs the generative AI model to generate or that the processor permits to be included in the article list information.

In one embodiment, a server, a terminal, and a communication network cooperate to implement the present invention. The server includes at least one processor, a main memory, a non-transitory storage device, and a network interface. The terminal includes a processor, a memory, a display, an input unit, and a communication interface. The server executes server-side application software, and the terminal executes client-side application software.

The server executes an operating system such as a general-purpose server operating system and runs an application framework such as a web application framework implemented in a high-level programming language. The server stores and executes program modules including a request reception module, a prompt generation module, a generative AI interface module, a post-processing module, a product information integration module, and an output formatting module. The terminal runs an application framework for graphical user interfaces, for example a cross-platform user interface framework, and stores and executes a display control module, an input control module, a communication module, and a state management module.

The terminal presents to a user a graphical user interface for entering hobby-related information. The terminal displays a text input region, buttons for submission, and an area for displaying recommended articles. The terminal maintains an internal state representation, for example in a key-value structure in memory, to hold at least a user input string and a list of article objects with attributes such as name, description, price, image reference, and purchase link.

The user uses the terminal to enter free-form natural language descriptions of an intended hobby or leisure activity. The user may input short phrases or long sentences, such as “I want to start photography,” “I want to start road cycling,” or “I want to start home coffee brewing with a budget under $300.” The terminal locally validates and normalizes the input, for example by trimming whitespace and limiting maximum length, and then sends the input as structured request data to the server through a communication protocol such as HTTPS.

The server receives the structured request data via its network interface. The server parses the incoming data using a parser in the request reception module, and stores the parsed data in a transient request object in memory. The server normalizes the input text with text normalization routines, converting control characters, standardizing line breaks, and optionally applying language detection. The server maintains a request log in the storage device where the normalized user text and associated metadata such as timestamps and terminal identifiers are stored for monitoring and future analysis.

The server generates a prompt sentence designed to control behavior of a generative AI model. The prompt generation module uses a template-based algorithm. The server stores in memory a plurality of template strings, each string defining structure and constraints of a prompt sentence. Each template may include placeholders for user input, language indicators, maximum item count, or budget constraints. The server selects an appropriate template based on factors such as the detected language, user attribute information, and preset condition information.

The server then fills the selected template with the normalized user text and any additional conditions. For instance, when the user input is “I want to start photography,” the server generates a prompt sentence such as:

“The user wants to start the following hobby: ‘I want to start photography.’ Please list the basic products needed for this hobby. Provide each item on a separate line in the format: ‘Item name—short reason why it is necessary.’Limit the list to 10 items.”

When the user input is “I want to start road cycling,” the server generates a prompt sentence such as:

“The user wants to start the following hobby: ‘I want to start road cycling.’ Please list the essential products needed to safely begin this hobby. Use bullet points and include safety-related items. Keep each explanation under 20 words.”

When the user input is “I want to start home coffee brewing with a budget under $300,” the server generates a prompt sentence such as:

“The user wants to start the following hobby: ‘I want to start home coffee brewing with a budget under $300.’ Please list the minimum essential products required under this budget. For each product, provide: name, approximate price range, and one-sentence justification.”

The server may alter specific parameters of the prompt sentence, such as the maximum number of items or the required explanation length, according to user attribute information stored in a user profile database, including expertise level, language preference, and device type. In this way, the server dynamically adjusts the structure and constraints of the prompt sentence to match computational resources and display capabilities of the terminal.

The server uses the generative AI interface module to transmit the prompt sentence to a generative AI model hosted either locally or on an external inference service. In one embodiment, the generative AI model is a neural network-based language model that has a transformer architecture with multiple encoder-decoder layers, multi-head attention mechanisms, and feed-forward layers. The model maintains large parameter matrices in a model storage area and performs inference on specialized hardware such as graphics processing units or tensor processing units.

The server represents the prompt sentence as a sequence of tokens by applying a tokenizer that maps character sequences to integer token identifiers. The generative AI model receives a token sequence as input and computes contextualized representations of the tokens through repeated application of attention operations and non-linear transformations. The generative AI model computes a probability distribution over a vocabulary at each step and generates an output token sequence by iteratively selecting tokens that maximize or approximate the probability distribution under a sampling scheme such as greedy decoding or top-k sampling. The generative AI model thereby outputs a text segment that contains a list of articles and associated reason statements or explanations.

The server receives the output of the generative AI model as a sequence of tokens, converts the tokens back to a text string using a detokenizer, and stores the resulting text as raw article list information. The post-processing module then analyzes the raw article list information. The server splits the text into separate lines, identifies delimiters such as hyphens or bullet symbols, and extracts, for each line, a candidate article name and explanation. The server constructs a data structure in memory, such as an array of article objects, each object including fields for article name, explanation, and ranking order.

The server applies rule-based normalization to the article objects. The server can standardize capitalization, remove duplicate items according to string similarity metrics, and cluster semantically similar items using vector representations computed by a text embedding model. The server assigns an identifier to each article, for example a hash value computed from normalized article name and explanation or an incrementing integer ID. The server thereby generates structured data that conforms to a defined schema, which includes at least an identifier, article name, description information, and acquisition-source placeholder.

The server further integrates product information using the product information integration module. The server queries a merchandise information storage device or an external merchandise information providing device with the normalized article name as a query key. The server receives responses including price information, image information, and purchase-link information, and associates such information with each article object by populating corresponding fields. In one embodiment, the server uses caching strategies and batched queries in order to reduce communication load with the external merchandise information providing device. The server maintains an index structure in the storage device mapping article names to product entries to accelerate lookup operations and reduce latency.

The server then passes the enriched article objects to the output formatting module. The server creates output data in a structured format, for instance as records with consistent field ordering and type information. The server may adapt the output format based on the terminal type; for example, for a small-screen terminal the server may omit long textual descriptions and images above a certain size, while for a larger display the server may include extended descriptions and multiple images per article. These adaptations reduce the amount of transmitted data and rendering workload while preserving essential information for the user.

The server transmits the output data to the terminal via the communication network. The terminal receives the output data, parses it using its communication module, and converts it into an internal state representation. The terminal then generates a visualization in which article objects are presented in a scrollable list, grid, or other layout. The terminal renders each article with at least its name and description, and, if available, its price and image. The terminal provides interactive controls, such as touch-sensitive areas, that invoke the purchase-link information; when the user selects such a control, the terminal opens a network resource, such as a purchase page, via an embedded browser or system browser.

The terminal thereby performs a technical operation on its hardware: the terminal controls its display to show article graphics, controls its network interface to open external purchase pages, and manages its local memory to maintain state between different views. The dynamic control of the prompt sentence and output data format by the server enables the terminal to display only data that is optimized for the specific hardware characteristics, which reduces rendering overhead and reduces communication bandwidth usage.

The server architecture and processing flow provide improvements to computer technology compared to traditional rule-based recommendation systems. In conventional systems, mapping high-level hobby descriptions to articles is handled by manually crafted rules, which are difficult to scale and often require multiple database queries per user interaction. In contrast, the present server uses a generative AI model with a transformer architecture to compress the semantic understanding of the user's hobby description into a single or limited number of inference operations that produce a structured list of relevant article candidates. This reduces the number of sequential database scans and manual mapping routines needed, thereby decreasing server-side computational load and latency.

The server improves accuracy of article recommendations by combining model output with structured normalization and enrichment. The server applies non-trivial post-processing algorithms, including similarity-based deduplication, schema mapping, and dynamic re-ranking based on user attribute information. These operations create a data representation that is better aligned with real product catalogs. As a result, the server produces article lists with higher relevance and lower redundancy than naive text generation alone.

The server further improves data management and communication efficiency by dynamically adjusting the wording format of the prompt sentence. For example, by instructing the generative AI model to output each item in a strict format such as “Item name-short reason why it is necessary” and limiting explanations to a fixed number of words, the server ensures that the generated text can be parsed with simple deterministic rules rather than complex natural language understanding algorithms. This constraint on model output format reduces processing complexity in the post-processing module and yields predictable data structures, which, in turn, decreases memory consumption and processing time.

The use of explicit constraints in the prompt sentence also exploits the internal scoring mechanism of the transformer-based generative AI model. By narrowing the output space through explicit formatting and item count constraints, the server indirectly shapes the probability distributions computed by attention layers, steering generation away from irrelevant or excessively verbose content. This leads to more compact outputs and reduces token counts, which reduces inference time on the model and bandwidth usage when transmitting responses back to the server.

The generative AI model itself is trained by the provider on large corpora of text data. During training, the model minimizes a loss function, such as cross-entropy loss between predicted token distributions and ground-truth tokens, and updates its weights through gradient-based optimization like stochastic gradient descent or its variants. The training process uses techniques such as mini-batching, learning rate schedules, and regularization. In some embodiments, the server further fine-tunes the model on domain-specific text related to hobby descriptions and product information by continuing training with supervised examples or reinforcement learning from human feedback. This fine-tuning processes increase the model's ability to generate more domain-appropriate article lists and reduces the frequency of irrelevant items.

The server employs a non-conventional processing strategy by combining prompt sentence generation, transformer-based text generation, structured post-processing, and dynamic adaptation based on device and user attributes. Unlike simple automation of human curation, the server modifies computational behavior in a way that human operators cannot practically replicate. For example, the server aligns the internal token-level attention operations of the generative AI model with externally imposed structured constraints, and then uses deterministic parsing and product database integration to transform the unstructured text into formalized data objects. This pipeline results in repeatable, machine-optimized mappings from natural language intent to transaction-ready article lists.

The system provides several technical effects with explicit causal relationships. Because the server constrains the output structure at the prompt level, the post-processing algorithms can be simplified to linear-time operations over a small number of lines, which reduces CPU utilization and memory overhead. Because the server enriches article objects with indexed product information and caches popular item mappings, subsequent requests for similar hobbies can be served with partial reuse of previously resolved product entries, leading to reduced database and network access. Because the server adapts the maximum number of articles according to device capabilities and network conditions, the volume of output data is bounded, which reduces average network transfer time and improves responsiveness on terminals with limited resources.

In an alternative embodiment, the server hosts the generative AI model locally on dedicated inference hardware instead of using an external inference service. The server stores model weights in a high-throughput storage tier and loads them into specialized accelerators. The server uses batching strategies to process multiple prompt sentences in parallel, further improving throughput and reducing average response time. In another embodiment, the server employs a smaller distilled model for low-resource environments, selected through a model selection module that takes into account current server load and latency goals.

In another embodiment, the terminal runs on a desktop computing device rather than a mobile device, and the server adjusts output format to include richer metadata, detailed descriptions, and comparison tables. In yet another embodiment, the terminal is integrated into a dedicated kiosk or in-store display system; in such cases, the server may generate prompts that emphasize physical availability and store-specific inventory, and the terminal may control peripheral devices such as barcode scanners or receipt printers as part of the article selection workflow.

In still another embodiment, the server supports multi-language processing by including language tags in the prompt sentence and by instructing the generative AI model to output responses in a specific language. For example, when the user input is in a first language and the product catalog is in a second language, the server generates a prompt sentence that instructs the model to express article names in the second language while preserving semantic compatibility. This configuration improves cross-language recommendation accuracy and avoids the need for separate machine translation steps in many cases.

Through these embodiments, the server and the terminal jointly perform a set of coordinated operations that go beyond abstract data manipulation. The server configures the internal functioning of a generative AI model, enforces structured output formats, integrates the model's output with indexed product databases, optimizes communication load according to device and network conditions, and delivers terminal-ready article lists. The terminal executes specialized visualization and interaction logic that is adapted to the structured data. This arrangement improves processing speed, recommendation accuracy, and communication efficiency, thereby constituting a concrete improvement in computer technology rather than a mere automation of human mental processes.

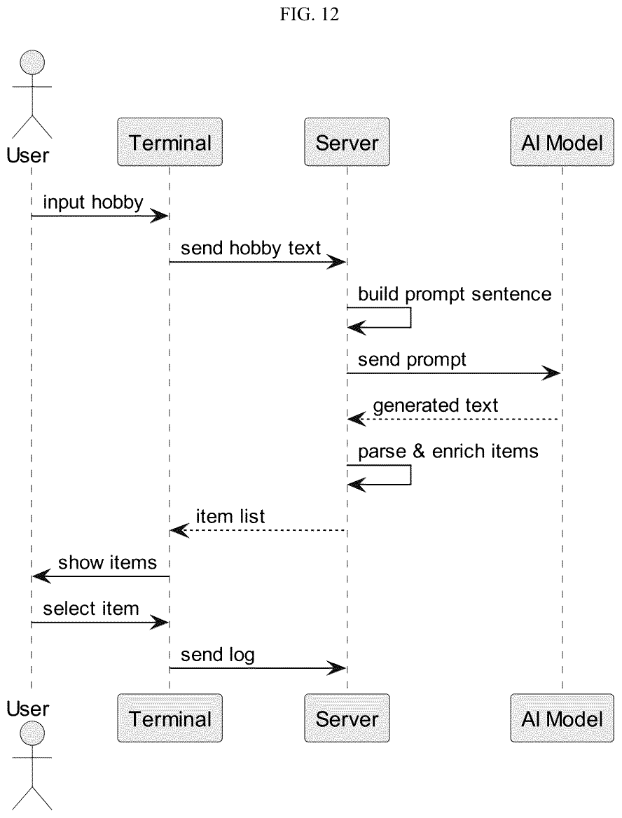

The following describes the processing flow using FIG. 12.

### Step 1

The terminal displays an input screen for hobby information.

The terminal initializes its internal state with an empty hobby input string and an empty article list array as initial values. The terminal renders a text input field, a submit button, and a result area on the display. The input of this step is the application startup event, and the output is a rendered user interface with ready-to-use input controls and an initialized state in memory.

### Step 2

The user inputs hobby-related text on the terminal.

The user types natural language text, such as “I want to start photography,” into the text input field and optionally edits or corrects the text. The terminal updates its internal state with every keystroke, reflecting the current string. The input of this step is user key and touch events, and the output is an updated state in the terminal memory that holds the final hobby description string.

### Step 3

The terminal validates and normalizes the hobby input.

The terminal takes the hobby description string as input, trims leading and trailing whitespace, replaces multiple spaces with a single space, and checks that the length is within a predefined limit. The terminal also checks that the string is not empty. If validation fails, the terminal outputs an error message to the display and does not proceed; if validation succeeds, the terminal produces a normalized hobby string as output to be used in a request payload.

### Step 4

The terminal constructs and sends a request to the server.

The terminal takes the normalized hobby string as input and embeds it into a structured request object, for example an object with a field “hobby_text.” The terminal serializes this object into a format suitable for network transmission and attaches HTTP headers indicating content type. The terminal then sends the serialized data to the server via the communication interface. The input of this step is the normalized hobby string, and the output is a network request transmitted over the communication line toward the server.

### Step 5

The server receives and parses the hobby request.

The server receives the request data via the network interface and forwards it to the request reception module. The server parses the incoming structured data, verifies its integrity, and extracts the hobby-related text field. The server logs the request metadata such as timestamp and terminal identifier into a persistent storage device. The input of this step is the raw network request stream, and the output is a normalized hobby text string stored in server memory and associated metadata in persistent storage.

### Step 6

The server determines context and selects a prompt template.

The server takes the hobby text and any available user attribute information or preset condition information as input. The server may perform language detection or examine user preference fields to infer language, experience level, or device characteristics. Based on this context, the server selects one of multiple stored prompt templates, such as a template for basic beginners, a safety-focused template, or a budget-constrained template. The input of this step is the normalized hobby text and context information, and the output is a selected prompt template identifier and template string.

### Step 7

The server generates a prompt sentence for the generative AI model.

The server takes the selected template string and the normalized hobby text as input. The server performs string substitution or formatting, inserting the hobby text and any conditions (such as budget or item count limits) into placeholder positions within the template. For example, when the user text is “I want to start photography,” the server generates the following prompt sentence:

“The user wants to start the following hobby: ‘I want to start photography.’ Please list the basic products needed for this hobby. Provide each item on a separate line in the format:

‘Item name—short reason why it is necessary.’Limit the list to 10 items.”

The output of this step is a complete prompt sentence that conforms to the constraints required for predictable model output.

### Step 8

The server tokenizes the prompt sentence and prepares a generative AI request.

The server takes the prompt sentence as input and applies a tokenizer associated with the generative AI model. The server converts the character sequence into a sequence of token identifiers and places this sequence into a structured request object along with model configuration parameters such as maximum output length and sampling settings. The input of this step is the prompt sentence, and the output is a generative AI model request object containing tokenized input and inference parameters.

### Step 9

The server transmits the model request to the generative AI model and executes inference.

The server sends the request object to the generative AI model engine, either locally or through an external inference service. The generative AI model receives the token sequence and propagates it through its transformer layers, computing attention scores and updated hidden representations at each layer. The model generates output tokens step by step under the specified constraints, such as limited number of items and enforced output format. The input of this step is the tokenized prompt and model parameters, and the output is a sequence of output tokens representing the model's generated text.

### Step 10

The server reconstructs the model output text and obtains raw article list information.

The server receives the output token sequence from the generative AI model and applies a detokenizer to map token identifiers back to characters. The server concatenates characters into a complete output string. This output string generally contains multiple lines, each line corresponding to one recommended article and an explanatory phrase. The input of this step is the sequence of output tokens, and the output is a raw article list text string stored in server memory.

### Step 11

The server parses the raw article list text into article objects.

The server takes the raw article list text as input and splits it at line breaks to obtain individual item lines. For each line, the server locates a delimiter such as a hyphen or bullet symbol and divides the line into an article name portion and a reason or description portion. The server constructs an article object data structure for each line, storing at least article name and description fields. The input of this step is the raw list text, and the output is an array of article objects with basic fields populated.

### Step 12

The server normalizes and deduplicates article objects.

The server takes the array of article objects as input and applies normalization functions, such as lowercasing titles for comparison and removing punctuation that does not affect identity. The server calculates similarity measures between article names, for example using string distance metrics or vector embeddings, and merges or removes objects that exceed a similarity threshold. The server assigns a unique identifier to each remaining article object. The input of this step is the unnormalized article array, and the output is a cleaned array of article objects with unique identifiers and normalized names.

### Step 13

The server enriches article objects with external product information.

The server takes the normalized article array as input and queries a merchandise information storage device or an external merchandise information provider using article names as query keys. The server receives product records containing price, image references, and purchase links, and maps these records to corresponding article objects by matching names or identifiers. The server writes the obtained price information, image information, and purchase-link information into fields of each article object. The input of this step is the normalized article array and product catalog data, and the output is an enriched article array where each article includes product-related attributes.

### Step 14

The server formats enriched article data for terminal output.

The server takes the enriched article array as input and constructs an output data structure that contains a list of record entries. For each article, the server ensures that fields are arranged in a predetermined order and that data types comply with the terminal's display constraints. The server may apply additional rules based on device type, such as truncating long descriptions or omitting large images for bandwidth-limited terminals. The input of this step is the enriched article array and device capability information, and the output is an output data structure optimized for transmission and display.

### Step 15

The server transmits the formatted output data to the terminal.

The server takes the output data structure as input and serializes it into a network-friendly representation. The server attaches appropriate response headers and sends the serialized data back to the terminal via the communication line. The server also logs response metrics such as data size and processing time for performance monitoring. The input of this step is the formatted output data structure, and the output is a network response message delivered to the terminal.

### Step 16

The terminal receives and parses the article list response.

The terminal receives the response message via its communication interface and passes it to the communication module. The terminal checks response status, extracts the serialized payload, and converts it back into an internal data structure representing the article list and its attributes. The input of this step is the raw network response, and the output is an in-memory article list representation suitable for rendering.

### Step 17

The terminal updates state and renders the recommended articles.

The terminal takes the in-memory article list as input and replaces or augments its current article list state. The terminal triggers a re-rendering of its user interface, creating visual components for each article entry. The terminal maps each article field, such as name, description, price, and image reference, to corresponding visual elements on the display. The input of this step is the parsed article list structure, and the output is a fully updated display showing recommended articles to the user.

### Step 18

The user reviews and selects recommended articles on the terminal.

The user visually inspects article entries, scrolls through the list, and compares descriptions and prices. The user may tap or click a specific article to see more details or to initiate a purchase. The terminal registers these interactions and loads detailed views or initiates actions based on the user's selection. The input of this step is the rendered list and user attention, and the output is user interaction events indicating interest in specific articles.

### Step 19

The terminal invokes purchase links for selected articles.

The terminal takes a user selection event and the corresponding article object as input. The terminal reads the purchase-link field and instructs the operating system or an embedded browser component to open the link. The terminal thereby initiates a network connection to an external commerce service. The input of this step is the article object with purchase-link information, and the output is a controlled transition to an external purchase interface on the device.

### Step 20

The server records usage patterns and refines processing parameters.

The server receives optional feedback or interaction logs from the terminal, such as which articles were selected or purchased. The server stores these logs in a usage database and analyzes them in aggregate. Based on this analysis, the server may adjust prompt templates, item count limits, or ranking rules to improve future recommendations. The input of this step is usage and interaction data from terminals, and the output is updated configuration parameters and refined processing behavior that influence subsequent prompt sentence generation and post-processing.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented product development and product recommendation systems suffer from several technical limitations in how processors acquire, structure, and present product-related information based on natural language input. In many existing systems, when a user inputs a natural language request, the system merely performs a keyword search against a predefined product database and returns matching records. Such processing often relies on rigid query generation and simple filtering logic, which causes several problems in terms of processing efficiency, data structure handling, and interface control.

First, existing systems do not effectively leverage a generative AI model to transform unstructured instruction information into structured product-related information. As a result, a processor must perform multiple separate operations, such as manual rule-based interpretation of user instructions, handcrafted mapping of attributes, and repetitive querying of a product database, which leads to increased processing complexity and latency. Furthermore, because the product-related information is not generated in a consistent structured format, subsequent normalization and user interface generation require additional ad hoc conversion steps, increasing memory usage and processing overhead.

Second, in many systems, there is no integrated mechanism for a processor to generate and utilize a virtual user profile derived from user instructions as a persistent computational construct. Without such a virtual user profile, the processor cannot maintain a coherent representation of user preferences across different interactions, and cannot systematically correlate generated product-related information with product planning information, design information, or market analysis information. This leads to inefficient use of computational resources for analysis and makes it difficult to programmatically derive product design support information that reflects inferred user characteristics.

Third, existing systems typically handle product information display and purchase link processing in a fragmented manner. For example, user interfaces are often generated by the client side using loosely structured data, which may require multiple round trips and client-side parsing and restructuring. This can result in inconsistent display formats, increased network payloads, and greater processing burden on terminal devices. In addition, processors in conventional systems often lack a unified control mechanism for converting generative AI output into normalized structured information that directly drives both user interface rendering and connection processing to purchase information processing devices.

Fourth, conventional market research support tools and product design support tools usually treat market research information, sales information, and user attribute information as static reference data. Such tools rarely integrate dynamically generated virtual user profiles and generated product-related information into the same computational pipeline. As a result, processors do not perform fine-grained comparison and correction or expansion of structured product information based on external information. This limits the depth and breadth of product information that can be programmatically generated and prevents efficient computer-implemented decision support for product development.

Accordingly, there is a need for a computer-implemented technique in which a processor, by cooperating with a generative AI model, (i) generates a virtual user profile and product-related information based on instruction information, (ii) normalizes the product-related information into structured information suitable for machine processing, (iii) generates user interface display data directly from the structured information, and (iv) compares the virtual user profile and product-related information with external information to correct or expand the structured information. Such a technique should improve the efficiency, consistency, and reliability of the underlying data processing operations executed by the processor, reduce redundant processing steps on terminal devices, and provide a technically improved mechanism for controlling product information presentation and purchase connection processing within a computer system.

The specific processing by the specific processing unit 290 of the data processing device 12 in Example 2 is realized by the following means.

The present invention provides a server comprising a processor configured to receive instruction information from a user, analyze the instruction information to generate a prompt sentence for a generative AI model, and instruct the generative AI model to generate a virtual user profile based on the prompt sentence; to input the prompt sentence into the generative AI model, cause the generative AI model to generate the virtual user profile, and further cause the generative AI model to generate product-related information associated with the virtual user profile based on the instruction information; to analyze the product-related information obtained from the generative AI model and normalize the product-related information into structured information including, for each product information item, at least a product name, price information, description information, image identification information, and purchase connection information; to generate user interface display data for providing product information based on the structured information and transmit the user interface display data to a terminal device so that the terminal device presents, on a display, visual elements including at least the product name, the price information, the description information, and the image identification information; to receive, from the terminal device, request information corresponding to selection of the purchase connection information or a selection operation of a product information item, and execute a connection process to a purchase information processing device based on the purchase connection information or a connection process to a purchase screen corresponding to the product information item in response to the request information; and to compare the virtual user profile and the product-related information with at least one of product planning information, design information, market analysis information, market research information, sales information, and user attribute information, and correct or expand the structured information and generate product design support information based on a result of the comparison. This enables the server to implement an integrated computational pipeline in which natural language instruction information is transformed via a generative AI model into normalized structured product information that directly drives user interface rendering and purchase connection processing, while dynamically refining the structured information using external market-related data, thereby improving the efficiency and technical quality of computer-based product information generation, presentation control, and product development support.

The term “processor” refers to a hardware-based information processing unit, such as a central processing unit or other computation circuitry, that executes machine-readable instructions to perform the functions described in the present specification and claims.

The term “user” refers to a human operator or an entity that provides instruction information to the system via an input interface of a terminal device.

The term “instruction information” refers to information received from a user, including natural language input, selection input, or other operation input, that expresses a requirement, preference, or request related to products or product development.

The term “prompt sentence” refers to a machine-readable representation of instruction information, typically expressed in natural language text, that is generated by the processor and provided as input to a generative AI model to control the content and format of an output produced by the generative AI model.

The term “generative AI model” refers to a machine learning model, such as a neural network-based text generation model, configured to generate output data including text or structured information based on input data such as a prompt sentence.

The term “virtual user profile” refers to information representing a hypothetical or inferred user, including at least characteristics, preferences, or behavioral tendencies, that is generated by the generative AI model based on a prompt sentence derived from instruction information.

The term “product-related information” refers to information associated with one or more products, including at least product names, features, attributes, prices, descriptions, images, or purchase links, generated by the generative AI model in association with a virtual user profile or instruction information.

The term “structured information” refers to product-related information that has been converted by the processor into a predefined data structure having one or more fields, such as fields for product name, price information, description information, image identification information, and purchase connection information, enabling systematic machine processing.

The term “product information item” refers to a unit of structured information corresponding to a particular product, including a set of fields describing attributes of the product.

The term “product name” refers to a designation or label used to identify a product within structured information.

The term “price information” refers to information indicating a monetary value or range, including optionally a currency type, associated with a product in structured information.

The term “description information” refers to textual or symbolic information that describes characteristics, features, or usage of a product.

The term “image identification information” refers to information used to identify or retrieve an image related to a product, including at least an image identifier, an image file name, an image uniform resource locator, or an image-related keyword.

The term “purchase connection information” refers to information used to establish a connection to a purchase information processing device or purchase screen, including at least a network address, a uniform resource locator, a resource identifier, or other connection parameter associated with a product.

The term “user interface display data” refers to data generated by the processor and transmitted to a terminal device, the data defining layout, content, and presentation attributes of visual elements for displaying structured information on a display.

The term “terminal device” refers to an information processing apparatus, such as a personal computer, smartphone, tablet, or other client device, that communicates with the server, receives user interface display data, and presents visual elements to a user.

The term “visual element” refers to a graphical component displayed on a screen of a terminal device, such as text, images, buttons, or interactive components, for presenting product-related information or receiving user input.

The term “request information” refers to information transmitted from a terminal device to the server, the information indicating at least a user selection of purchase connection information or a user selection operation with respect to a product information item.

The term “purchase information processing device” refers to an information processing system, which may be part of or separate from the server, that provides a purchase screen or executes processing related to ordering, payment, or transaction completion for products.

The term “purchase screen” refers to a user interface screen that provides detailed product information, order options, payment options, or transaction controls enabling a user to perform a purchasing procedure.

The term “product planning information” refers to information representing plans or concepts for products under development, including at least target user segments, planned features, and positioning strategies.

The term “design information” refers to information related to the design of a product, including at least specifications, configurations, appearance designs, or functional structures.

The term “market analysis information” refers to information derived from analysis of a market, including at least market size, trends, competitive products, or segment characteristics.

The term “market research information” refers to information obtained from surveys, interviews, observations, or other research activities about markets, customers, or products.

The term “sales information” refers to information representing sales performance of products, including at least sales volume, revenue, sales channels, or temporal sales patterns.

The term “user attribute information” refers to information representing characteristics of users, including at least demographic attributes, behavioral attributes, or preference attributes.

The term “product design support information” refers to information generated by the processor to support decisions in product design, including at least recommended specification changes, function configuration adjustments, or price setting adjustments based on a virtual user profile and structured information.

The term “product specification information” refers to information describing technical or functional specifications of a product, such as dimensions, performance parameters, or component configurations.

The term “function configuration information” refers to information describing a set, combination, or allocation of functions implemented in a product.

The term “price setting information” refers to information indicating a proposed or determined price or price range for a product and conditions under which the price is applied.

The server is implemented as an information processing apparatus including at least one processor, a main memory, a nonvolatile storage device, and a network interface. The server executes an operating system such as a general-purpose server operating system, and executes one or more application programs including a web application program, an application programming interface (API) program, and a generative AI model client program. The server uses a database management program to store and manage structured information, virtual user profiles, and product-related information.

The terminal is implemented as a client information processing apparatus, such as a smartphone, a tablet, or a personal computer, including a processor, a memory, a display, and one or more input devices such as a touch panel, a keyboard, or a pointing device. The terminal executes a web browser program or a native application program, and communicates with the server through a communication network such as the Internet using a communication protocol such as HTTP over TLS.

The user operates the terminal to input instruction information in the form of a prompt sentence. The user inputs, for example, the following prompt sentences as plain text into an input field of a web page or an application screen displayed by the terminal:

“Show me the latest smartphones with excellent cameras.”

“Recommend budget laptops for students under 600 dollars.”

“List ergonomic office chairs suitable for 8+ hours of work.”

“Please show the latest smartphones available this year, focusing on camera quality and battery life.”

“List budget gaming laptops under 1200 dollars with at least 16 GB RAM.”

“Recommend office chairs suitable for long hours of work, with good lumbar support.”

The terminal captures the prompt sentence input by the user and transmits the prompt sentence as instruction information to the server via the communication network. The terminal maintains a lightweight data structure, such as a key-value pair, containing at least a user identifier, a session identifier, and the prompt sentence as plain text, and sends this data structure in a request message to the server.

The server receives the request message and temporarily stores the instruction information in the main memory. The server normalizes the instruction information by applying, for example, whitespace trimming, character encoding normalization, and length limitation. The server stores the normalized instruction information in a database as a record, together with metadata such as a timestamp and a terminal identifier. By performing such normalization and storage at the server, the system reduces redundant parsing and validation logic on the terminal side and centralizes control of data quality, thereby improving reliability and reducing inconsistencies between different client implementations.

The server analyzes the instruction information to generate a prompt sentence for a generative AI model. The server constructs an internal representation of a prompt sentence by combining the user-provided text with additional control tokens and formatting directives. The server maintains a template structure including a system role section, a user content section, and an output format section. The server inserts the user's prompt sentence into the user content section and sets the output format section to require a machine-readable structure, such as a list of product attributes including product name, price, description, and image-related keywords. This template-based construction of the prompt sentence is performed by deterministic string concatenation and token sequence assembly routines executed by the processor.

The server uses a generative AI model implemented as a trained neural network model stored either locally or accessible via a network. In one embodiment, the generative AI model is a transformer-based neural network including multiple self-attention layers, feed-forward layers, and normalization layers. The model is parameterized by a plurality of weight matrices and bias vectors that are stored in a model storage area on a computation node such as a graphics processing unit. The generative AI model processes tokenized input sequences representing the prompt sentence and outputs token sequences representing generated text.

The server tokenizes the prompt sentence into subword tokens using a predetermined tokenization algorithm such as byte pair encoding. The server represents each token as an integer index and constructs an input tensor of token indices. The server then transmits the input tensor and model control parameters, such as maximum output length, temperature, and sampling strategy, to the generative AI model execution environment. The generative AI model, in response, executes a sequence of matrix operations including matrix multiplication and non-linear activation to compute, for each output token position, a probability distribution over a vocabulary of candidate tokens. The model applies a decoding algorithm, such as top-k sampling or nucleus sampling, to select output tokens based on the probability distribution.

The server receives the generated token sequence from the generative AI model and decodes the token sequence into generated text. The server stores the generated text in the main memory as an intermediate result. The generated text includes a representation of a virtual user profile and product-related information associated with that virtual user profile. The virtual user profile includes, for example, characteristic fields such as age range, budget preference, usage scenarios, and preference for particular features. The product-related information includes, for each product candidate, fields such as a product name, price-related text, a description, and a list of keywords indicating image characteristics or functional attributes.

The server parses the generated text to construct structured information as machine-readable data. The server uses a parser module that identifies delimiters, field labels, and list structures within the generated text. The server converts the parsed content into a structured data representation such as an array of product information items. Each product information item is represented, for example, as a record including fields such as product_name, price_raw, description_raw, image_keyword_list, and purchase_url_placeholder. The server also extracts virtual user profile information into a separate data structure including fields such as profile_id, preference_features, budget_range, and usage_contexts.

The server normalizes the structured information into a further refined structure. For price information, the server applies numeric parsing logic to convert strings such as “799 dollars” into a numeric value and a currency code. The server may, for example, apply regular expression matching to identify digit sequences and currency terms, and then map the terms to internal currency identifiers. The server determines, if necessary, a price range by applying thresholds or rules defined in configuration data, and stores normalized price information in fields such as price_value, price_min, price_max, and currency_code. For description information, the server applies text length limitation and sentence segmentation to generate a concise summary description suitable for user interface display.

The server maps image identification information into concrete image resources. The server may maintain a mapping table associating image-related keywords with image resource identifiers stored in an image repository. The server performs, for each image keyword list, a lookup operation against the mapping table and selects one or more image resource identifiers that have the highest similarity score. The server then constructs an image uniform resource locator for each selected image resource, using a base path for a content delivery network and the resource identifier as a path segment. By performing such mapping on the server, the system reduces the amount of logic required at the terminal and enables consistent image selection policies across different terminals.

The server generates purchase connection information based on the structured information and external databases. The server may maintain a product catalog database that stores records including product identifiers, canonical product names, actual purchase uniform resource locators, and current price data. The server compares the generated product names and other attributes with records in the product catalog database using similarity computation algorithms, such as cosine similarity on vectorized representations of product names. The server selects a product catalog record whose similarity score exceeds a threshold and uses the corresponding purchase uniform resource locator as purchase connection information. If a direct match is not found, the server can generate a generic purchase connection information entry pointing to a search result page on a commerce platform, using the product name and keyword information as query parameters.

The server composes user interface display data from the structured information. The server defines a layout template that includes slots for product images, product names, price information, and descriptions. The server fills the slots with corresponding fields from the structured information, and generates a representation of a user interface in a markup language such as a structured document format or in a structured message for a client-side rendering framework. The server includes, in association with each product information item, an interaction identifier or an encoded token that uniquely identifies the product information item when a selection operation is received from the terminal.

The terminal receives the user interface display data and interprets the data according to a predetermined communication protocol. The terminal renders visual elements on a display by instantiating user interface components such as image views, text labels, and buttons. The terminal displays the product names, normalized price information, truncated descriptions, and images retrieved using the image uniform resource locators. The terminal associates selection events with the interaction identifiers or tokens embedded in the user interface display data, and sends request information to the server when the user selects a particular product or purchase option.

The server receives the request information from the terminal and identifies the selected product information item based on the interaction identifier or encoded token. The server retrieves the corresponding purchase connection information from the structured information stored in the main memory or the database. The server then performs processing to connect the terminal to a purchase information processing device. The server may, for example, generate a redirection response including a uniform resource locator of the purchase screen, or may initiate a session with a commerce platform and return a session-specific purchase uniform resource locator to the terminal. In either case, the server controls the network communication so that the terminal is connected to a purchase screen corresponding to the selected product information item.

The server further compares the virtual user profile and the product-related information with external information such as product planning information, design information, market analysis information, market research information, sales information, and user attribute information. The server retrieves such external information from one or more databases or external systems, and converts these data into a common representation, such as feature vectors describing product attributes, user segments, or market segments. The server computes similarity metrics or divergence metrics between the virtual user profile features and external information features. Based on the comparison results, the server corrects or expands the structured information. For example, when the virtual user profile suggests a strong preference for a certain feature not well represented in existing product planning information, the server may add candidate product features to product design support information and mark corresponding product information items as potential design targets.

The server generates product design support information that includes recommendations for adjusting product specification information, function configuration information, and price setting information. The server may apply rule-based logic, such as associating high preference scores for certain features with proposed increases in specification attributes, or may apply optimization algorithms that balance target feature coverage against cost constraints. The server outputs the product design support information via a user interface intended for product developers or planners, enabling them to view synthesized proposals derived from the virtual user profile and external information.

The server, by implementing the above-described processing pipeline, achieves technical improvements in computer operation. Because the server constrains the generative AI model output to a predetermined structured format and normalizes product-related information into machine-friendly fields, the server reduces the amount of client-side parsing and conversion computation. This reduction decreases data size transmitted between the server and the terminal, thereby reducing communication load. Furthermore, by using a single structured information representation to drive both user interface rendering and purchase connection processing, the server eliminates duplicate data transformations, improving processing speed and memory efficiency.

The generative AI model used by the server is trained in advance using a combination of supervised learning and unsupervised learning. The server, during model training, uses training data sets consisting of input prompt sentences and target output structures including virtual user profiles and product-related information. The generative AI model learns to minimize a loss function, such as a cross-entropy loss between predicted token distributions and target token sequences, through weight updates performed by gradient descent methods. The generative AI model may also be fine-tuned with domain-specific data so that the output reflects realistic product attributes and user profiles. By encoding such training procedures and loss functions in the model, the server ensures that the generative AI model performs non-trivial inference that goes beyond simple rule-based lookup and yields high consistency in structured outputs.

The server controls the generative AI model with explicit decoding parameters, such as temperature and top-k thresholds, to reduce output variability and to promote outputs closer to the expected structured format. The server monitors whether the generated text satisfies predetermined structural constraints and can, if necessary, perform a corrective re-generation by providing an auxiliary prompt sentence that instructs the model to correct formatting errors. This feedback loop is managed programmatically by the server and results in a higher success rate of usable structured information generation, which directly improves processing throughput and reduces the need for manual correction.

The server employs non-traditional computational flows that are distinct from simple human task automation. For example, the server not only translates a user prompt to a search query but also uses the generative AI model to synthesize virtual user profiles and hypothetical product variants, and then systematically compares them with existing planning and market data. This combination of generative modeling, structured normalization, and feature-level comparison constitutes a technical improvement in data handling and inference within the computer system. The system thereby achieves improved result coverage and precision when generating candidate products and design support information, compared to conventional systems that rely solely on direct database queries or static rule sets.

In one embodiment, the server uses an internal feature representation in which both virtual user profile characteristics and product attributes are mapped into a shared vector space. The server computes distances or similarities in this space using vector operations. This configuration allows the server to efficiently retrieve and rank product information items that are most consistent with the virtual user profile. The use of such vector space operations within the server reduces the computation time required to identify relevant products compared to brute-force rule evaluation, and improves scalability when the number of products and profiles increases.

In another embodiment, the server may execute the generative AI model locally on hardware acceleration devices such as graphics processing units or tensor processing units. The server allocates batches of prompt sentences and performs parallel inferencing to generate virtual user profiles and product-related information for multiple users concurrently. This parallel processing improves throughput and reduces average response time, thereby contributing to an overall improvement in system performance.

In a further embodiment, the server may provide alternative generative AI models with different architectures or resource profiles, such as a larger model for high-precision generation and a smaller model for low-latency responses. The server selects an appropriate model based on factors such as available computational resources, network conditions, or priority of the user session. By controlling model selection and generation parameters dynamically, the server can optimize trade-offs between accuracy and speed at runtime, which is a technical effect not achievable by a static, rule-based system.

The terminal may be implemented in multiple forms. In one variation, the terminal is a web browser executing client-side scripts that render user interface elements using markup and style definitions received from the server. In another variation, the terminal is a native mobile application that receives abstract layout definitions from the server and maps them to native user interface components. In either case, the terminal benefits from the server's structured information because the terminal only needs to perform minimal mapping from structured information fields to display components, reducing the number of instructions executed on the terminal processor and minimizing the risk of inconsistency between different terminal types.

The user may use the system not only for immediate purchase decisions but also for exploring hypothetical product concepts. For example, the user may enter a prompt sentence such as “Imagine a smartphone for outdoor photographers who travel frequently and need very long battery life and water resistance.” The server generates a virtual user profile reflecting preferences of outdoor photographers and produces product-related information that includes hypothetical product features and suggested specifications. The server then compares these outputs with existing product planning information and can highlight gaps or opportunities in the current product lineup. This process supports product development teams by presenting technically coherent suggestions derived from complex, high-dimensional relationships that are difficult to derive using conventional tools.

By implementing the combination of generative AI model control, structured normalization, user interface integration, and comparative analysis with external information, the system provides a concrete and technically grounded improvement to the way computers process, manage, and present product-related information based on natural language prompt sentences. The system does not merely accelerate human reasoning but restructures the computational pipeline itself to achieve improved consistency, reduced latency, and enhanced capability to handle diverse and complex product-related data.

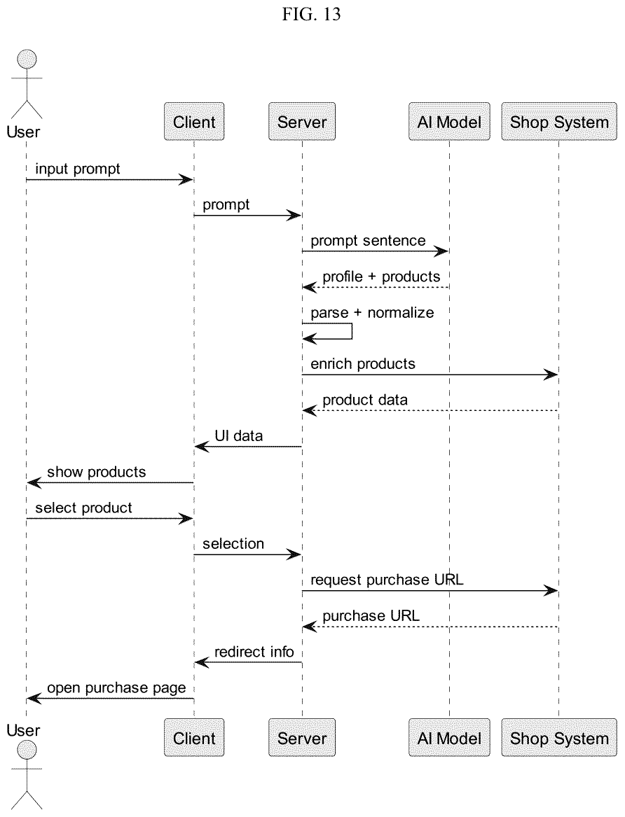

The following describes the processing flow using FIG. 13.

### Step 1

User operates the terminal and inputs instruction information as a prompt sentence. User opens a web page or an application screen provided by the server, selects an input field, and types a natural language prompt sentence such as “Show me the latest smartphones with excellent cameras.” or “Recommend budget laptops for students under 600 dollars.” User then triggers a submission operation, for example by pressing an enter key or tapping a “Generate” button.

Input: User provides natural language text as the prompt sentence.

Output: User causes the terminal to hold the prompt sentence in an input buffer and to initiate a transmission request toward the server.

### Step 2

Terminal captures the prompt sentence and constructs a request message. Terminal retrieves the text content from the input field, associates it with metadata such as a session identifier and a user or device identifier, and encapsulates these values into a structured message, for example a JSON object containing fields like “prompt_sentence”, “session_id”, and “client_type”. Terminal then establishes a secure communication channel to the server using a protocol such as HTTPS and transmits the structured message as the body of a request.

Input: Terminal receives the prompt sentence and local metadata from its user interface components and runtime environment.

Output: Terminal outputs a formatted request message containing the prompt sentence and metadata, and sends the message to the server over the network.

### Step 3

Server receives the request message and performs validation and normalization of the instruction information. Server reads the request from a network socket via a web server component and passes the body to an application component. Server parses the structured message to extract the prompt sentence and the metadata fields. Server trims leading and trailing whitespace, checks character encoding, verifies that the prompt sentence length is within predefined limits, and rejects or sanitizes control characters. Server may log the normalized instruction information into a database together with a timestamp for later analysis.

Input: Server receives a structured request message containing at least the prompt sentence and metadata.

Output: Server produces a normalized prompt sentence and associated metadata stored in memory and optionally persisted in a database.

### Step 4

Server constructs a model-ready prompt sentence for the generative AI model. Server prepares a composite prompt structure that includes a role description, constraints, and the normalized prompt sentence. For example, server generates a control string such as: “System: You are a product recommender that must output products as structured entries. User: [user's prompt sentence]. Constraints: Output product list with fields: name, price, description, image_keywords, purchase_url_placeholder.” Server concatenates these components according to a template and stores the resulting text as a model input string.

Input: Server receives the normalized prompt sentence and internal template definitions.

Output: Server generates a composite model input prompt sentence suitable for use with the generative AI model.

### Step 5

Server tokenizes the composite prompt sentence and sends it to the generative AI model. Server applies a tokenization algorithm, such as byte pair encoding, to convert the composite prompt sentence into a sequence of token identifiers. Server builds an input tensor that includes token identifiers and positional indices, and sets model parameters such as maximum output length, temperature, and sampling configuration. Server then transmits the tensor and parameters to a generative AI model runtime, either locally or over a network, via an API call.

Input: Server receives the composite model input prompt sentence as text.

Output: Server outputs an encoded token sequence and associated model parameters to the generative AI model runtime.

### Step 6

Server obtains generated output from the generative AI model and decodes it to text. Server receives from the generative AI model a sequence of generated token identifiers representing model output. Server applies a decoding algorithm to convert these token identifiers back into a character string, respecting a predefined character encoding. Server stores the generated character string as raw model output in memory for subsequent parsing.

Input: Server receives a sequence of output token identifiers and possibly log-probabilities from the generative AI model.

Output: Server outputs a raw generated text string that includes a representation of a virtual user profile and associated product-related information.

### Step 7

Server parses the raw generated text into intermediate structured fields. Server applies a parsing procedure that searches for delimiters, labels, or structural markers in the generated text, for example markers for sections such as “Profile:” and “Products:”, and markers for product fields such as “Name:”, “Price:”, “Description:”, and “ImageKeywords:”. Server segments the text into a virtual user profile part and a product list part, and then splits the product list into individual product entries. Server constructs intermediate data objects for each product entry containing raw field values and constructs an object for the virtual user profile containing raw profile attributes.

Input: Server receives raw generated text from the generative AI model.

Output: Server produces intermediate unnormalized data structures representing the virtual user profile and a list of product entries with raw fields.

### Step 8

Server normalizes product-related information into structured information. Server iterates over each intermediate product entry and applies field-specific normalization logic. For price fields, server uses pattern matching or regular expressions to extract numeric values and currency indicators, converting them into standardized numeric fields and a currency code. For description fields, server enforces maximum length and may remove redundant whitespace or control sequences. For image keyword fields, server splits comma-separated text into lists of individual keywords. Server also ensures that required fields such as product name and price are present, and discards or flags entries that fail validation. Server stores the normalized products in a structured format such as an array of records with defined fields, and stores the virtual user profile in a separate structure with normalized feature fields.

Input: Server receives intermediate product and profile structures with raw text fields.

Output: Server outputs normalized structured information including a list of product information items and a normalized virtual user profile representation.

### Step 9

Server enriches the structured product information using external product data sources. Server queries one or more product catalog databases or external product APIs using attributes such as normalized product name and image keywords as search parameters. Server sends search queries and receives product records that include canonical product identifiers, current prices, stock status, and reliable purchase URLs. Server computes similarity or matching scores between the AI-generated product information and database records, for example using text similarity functions. Server selects matching records above a threshold and updates the structured information by inserting canonical product identifiers, replacing placeholder purchase URLs with actual purchase URLs, and updating or confirming price and availability information.

Input: Server receives normalized structured product information and access to product catalog data.

Output: Server produces enriched structured information containing, for each product information item, validated product attributes and purchase connection information.

### Step 10

Server maps image identification information to concrete image resources. Server uses the image keywords and product identifiers in the structured information to look up corresponding image resources in an image repository or metadata index. Server computes scores using keyword matching or tag-based indexing to select one or more image resources for each product. Server constructs image URLs by combining repository base paths with image resource identifiers. Server writes the resulting image URLs into the structured information in place of or in addition to the image identification keywords.

Input: Server receives structured information containing image identification keywords and optionally product identifiers.

Output: Server outputs updated structured information that includes concrete image resource locations for each product information item.

### Step 11

Server generates user interface display data based on the structured information. Server selects a layout template that defines how product cards or list entries are arranged on the terminal screen. Server inserts, into the template, product fields such as product name, price, description, and image URL for each product item, and associates each item with an interaction identifier or token. Server packages the layout structure, field values, and interaction identifiers into a response payload, which may be expressed in a structured description language or API-specific format. Server then transmits the user interface display data to the terminal over the network.

Input: Server receives fully normalized and enriched structured information containing product fields, image URLs, and purchase connection information.

Output: Server outputs user interface display data that encodes visual layout and data binding for product information items and sends it to the terminal.

### Step 12

Terminal receives the user interface display data and renders visual elements. Terminal parses the received data and creates user interface components such as image views, text labels, and buttons for each product item. Terminal binds component properties to corresponding fields in the user interface display data, so that product names, prices, and descriptions are displayed. Terminal issues separate network requests to retrieve image files from the image URLs and draws the images within the layout. Terminal presents the rendered view on the display, allowing the user to scroll and view the product information.

Input: Terminal receives user interface display data from the server.

Output: Terminal outputs rendered visual elements on the display, providing the user with an interactive product list or grid.

### Step 13

User reviews the displayed product information and selects a product. User examines product names, descriptions, prices, and images shown on the display, and identifies a product of interest. User performs a selection operation, such as tapping a product card or pressing a “Buy” or “Details” button associated with a product.

Input: User receives visual product information via the terminal display.

Output: User generates a selection input event on the terminal, indicating a chosen product or purchase option.

### Step 14

Terminal captures the selection operation and sends request information to the server. Terminal detects the user's input event via event listeners attached to user interface components. Terminal determines the interaction identifier or token associated with the selected product item and retrieves any local metadata needed to form a request. Terminal constructs a request message that includes at least the interaction identifier and session information, and transmits this message to the server using the established communication protocol.

Input: Terminal receives a user selection event and associated interaction identifier from its user interface layer.

Output: Terminal outputs request information addressed to the server, specifying the selected product information item.

### Step 15

Server processes the request information and resolves purchase connection information. Server parses the request message, extracts the interaction identifier, and uses it to look up the corresponding product information item in the structured information stored in memory or in a database. Server retrieves the purchase connection information, such as a purchase URL or a reference to a purchase information processing device, associated with the selected product. Server may also generate tracking identifiers or log the selection event for analytics.

Input: Server receives request information containing an interaction identifier for a selected product.

Output: Server produces a resolved purchase connection endpoint and optionally logging data about the selection.

### Step 16

Server connects the terminal to a purchase information processing device or purchase screen. Server generates a response that either includes a redirection to a purchase URL or contains connection parameters for a purchase information processing system. Server may return an HTTP redirect response pointing to the purchase screen or may return a payload that instructs the terminal to open a specific purchase interface. By sending this response, server causes the terminal to establish communication with the purchase information processing device and to load a corresponding purchase screen.

Input: Server receives a resolved purchase connection endpoint derived from structured information.

Output: Server outputs a response that triggers a redirection or connection from the terminal to the purchase information processing device or purchase screen.

### Step 17

Server analyzes virtual user profile and structured product information against external information for design support. Server retrieves the normalized virtual user profile and the structured information used for display, and compares them with external data such as market research information, sales information, and existing product planning information stored in databases. Server converts these data into internal feature vectors and applies similarity, clustering, or ranking algorithms to determine relationships between inferred user preferences and existing products or plans. Server generates product design support information such as recommended specification changes or new feature combinations.

Input: Server receives virtual user profile data, structured product information, and external information sources.

Output: Server produces product design support information and updated analytical summaries that can be presented to users responsible for product development.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional recommendation and planning systems typically treat content generation, user modeling, and analytics as independent subsystems. In such architectures, a server may retrieve static records from a data repository and apply fixed heuristic rules to present items to a user, while a separate analytical tool is used offline to construct personas or target user profiles for product planning. This separation leads to several technical problems in computer-implemented environments.

First, when the server handles user input, it often processes the input in a simplistic, keyword-based manner and ignores dynamic context such as fine-grained behavior history and real-time emotion state. As a result, the processor tends to execute redundant database queries and rule evaluations that do not adapt to the changing state of the user, causing inefficient use of memory, processor cycles, and network bandwidth. For example, the server may repeatedly retrieve broad product sets, only to later discard many entries after a separate scoring stage, which increases data traffic and latency.

Second, existing systems usually call a generative AI model in an ad-hoc way, without a structured prompt generation process that incorporates multiple heterogeneous signals (preference, behavior history, and emotion). Because the prompt is not systematically constructed from these machine-readable signals, the generative model often produces outputs that are poorly aligned with downstream retrieval and ranking modules. The server then must perform additional text post-processing and approximate matching against product catalogs or other information collections, which increases computational overhead and can cause inconsistent results, including mismatches between generated abstract items and actual database items.

Third, conventional server architectures for persona generation in product or service development are typically offline, manual, and decoupled from real-time user interaction logs. A planner may input high-level descriptions into a separate tool, and the generated personas are stored in documents that are not directly connected to transaction logs or recommendation behavior. This prevents the processor from systematically comparing persona characteristics with actual market data, and from feeding selection and conversion signals back into the generative pipeline. As a consequence, the computer system cannot automatically refine prompt structures, ranking conditions, and data selection based on observed user responses; this leads to suboptimal allocation of computational resources and increased time and cost for iteration.

Fourth, existing implementations rarely unify: (i) interpretation of user input (including emotion recognition), (ii) generation of a prompt sentence to a generative AI model, (iii) mapping of abstract generative outputs to concrete items in an information collection, (iv) emotion-aware ranking, and (v) feedback-driven adjustment of both the prompt sentence and ranking logic. Without such unification in a single processor-controlled pipeline, the system must shuttle intermediate results between disparate services, causing format conversions, unnecessary network calls, duplicated processing, and increased latency. This degrades throughput and responsiveness, particularly when serving many terminals concurrently.

Accordingly, there is a need for a computer-implemented technique in which a processor centrally manages acquisition and analysis of user input, emotion state, and behavior history; automatically constructs optimized prompt sentences for a generative AI model; maps abstract generative outputs to concrete records in an information collection; performs emotion-and history-aware ranking of those records; and uses observed interaction histories to adjust prompt structures and ranking parameters, while also generating and exploiting target user images for product or service design. Such a technique should improve computational efficiency, reduce redundant data processing, and enhance the consistency and quality of outputs in a way that is technically advantageous over conventional architectures.

The specific processing by the specific processing unit 290 of the data processing device 12 in Application Example 2 is realized by the following means.

The present invention provides a server comprising a processor configured to receive and interpret information from a user, to acquire preference-related information and behavior history information of the user and analyze the information to specify an interest object of the user, to acquire emotion-related information of the user based on an utterance or an expression of the user and specify an emotion state of the user, to generate a prompt sentence to be input to a generative information processing model on the basis of the interest object, the behavior history information, and the emotion state, to input the prompt sentence to the generative information processing model and generate candidate information related to the interest object by using the generative information processing model, to map abstract items included in the candidate information to concrete items obtained from an information collection, to rank the concrete items on the basis of the emotion state and the behavior history information and generate a group of items to be presented, to generate connection information to an acquisition procedure screen for each item in the group of items and present the group of items together with the connection information to a terminal of the user, and to analyze input information from the user, generate a prompt sentence for instructing the generative information processing model to generate a target user image, generate the target user image by using the generative information processing model, and utilize the target user image as a viewpoint and an opinion provider for product development or service design. This enables the server to execute an integrated and feedback-driven pipeline in which user input, emotion signals, and behavior history are converted into optimized prompt sentences for a generative AI model, generative outputs are deterministically mapped and ranked against a structured information collection, and interaction histories are used to adapt both prompt construction and ranking parameters while simultaneously generating and exploiting target user images, thereby improving computational efficiency, response latency, and the technical quality and consistency of the system's outputs.

The term “user” refers to a human or organizational entity that provides input information to the system through a terminal and receives items, target user images, or other outputs from the system.

The term “terminal” refers to an information processing apparatus, such as a computing device, display device, or communication device, that is configured to transmit user input to the server and present outputs received from the server.

The term “server” refers to an information processing apparatus, including at least one processor and a memory, that is configured to execute the functions of receiving user information, generating prompt sentences, invoking a generative information processing model, processing outputs of the model, and providing results to the terminal.

The term “processor” refers to a hardware computation element, such as a central processing unit, a graphics processing unit, or another programmable processing circuit, that is configured to execute instructions to implement the functions described for the server.

The term “information collection” refers to a set of data records stored in at least one storage device, including structured or semi-structured data such as item records, product records, service records, or other entities that can be retrieved and associated with user-relevant content.

The term “information from a user” refers to data provided by the user, including at least text input, selection input, or interaction events, and optionally including speech data, image data, or gesture data that are captured by the terminal and transmitted to the server.

The term “preference-related information” refers to information indicative of the interests, likes, or priorities of the user, including explicit preference declarations and implicit preference signals inferred from behavior history.

The term “behavior history information” refers to information representing past actions of the user within the system or a related environment, including at least viewing history, selection history, access logs, acquisition procedure logs, and transaction records.

The term “interest object” refers to a subject, category, or domain, such as a hobby, product field, or service field, that is inferred or specified as a main focus of the user based on preference-related information and behavior history information.

The term “emotion-related information” refers to data from which an emotion state of the user can be inferred, including at least text content, prosodic features of speech, facial expression data, posture data, and interaction patterns.

The term “emotion state” refers to a classification or quantitative representation of a psychological condition of the user, such as enjoyment, excitement, anticipation, anxiety, or another affective state, as recognized by an emotion analysis process executed by or for the server.

The term “generative information processing model” refers to a parameterized computational model, such as a generative artificial intelligence model or a neural network model, that is configured to generate output information in response to input data including at least a prompt sentence.

The term “prompt sentence” refers to a sequence of symbols, typically natural language text, generated by the processor for input to the generative information processing model, the sequence encoding instructions, constraints, or context that condition the behavior of the generative information processing model.

The term “candidate information” refers to output data generated by the generative information processing model in response to a prompt sentence, including at least abstract items, item descriptions, or candidate entities relevant to an interest object.

The term “abstract item” refers to a representation of an entity, such as a product, service, or content item, that is described in generic or conceptual terms without being directly bound to a specific record in the information collection.

The term “concrete item” refers to a specific record or entity in the information collection, such as a particular product record or service record, that can be selected, ranked, and presented to the user and for which acquisition procedure information can be generated.

The term “mapping” refers to a process in which at least one abstract item in candidate information is associated with at least one concrete item in the information collection based on similarity of attributes, categories, or textual descriptions.

The term “rank” refers to the act of assigning an order or score to a plurality of concrete items based on one or more criteria, including at least the emotion state, behavior history information, and possibly additional evaluation parameters.

The term “group of items” refers to a subset of concrete items that has been selected and arranged by the processor, typically in a ranked order, for presentation to the user.

The term “connection information” refers to information for accessing an acquisition procedure screen or another resource associated with a concrete item, including at least a network address, a uniform resource locator, or a deep link identifier.

The term “acquisition procedure screen” refers to a presentation generated by an information processing apparatus, such as a transaction page or detail page, that enables the user to perform at least part of a process for acquiring or registering for a concrete item.

The term “target user image” refers to a structured or unstructured representation of a hypothetical or characteristic user, including attribute descriptions and behavioral tendencies, generated by the generative information processing model based on prompt sentences derived from input information.

The term “selection history” refers to records indicating which concrete items in one or more groups of items were selected, clicked, or otherwise chosen by the user.

The term “acquisition procedure completion history” refers to records indicating which concrete items have had an associated acquisition procedure completed, such as a purchase, enrollment, or subscription, by or for the user.

The term “market research information” refers to data obtained from sources such as surveys, usage analytics, or external research datasets that describe characteristics or behaviors of a population related to products or services.

The term “characteristics of the target user image” refers to attributes, preferences, and behavioral indicators contained in or derived from the target user image, which can be compared with market research information.

The term “reaction information” refers to data representing responses of the user to a group of items, including at least selection events, dwell times, scrolling behavior, and completion or abandonment of acquisition procedures.

The term “product development” refers to a process in which specifications, features, or configurations of a product are designed, evaluated, or modified, at least in part, based on information processed by the system.

The term “service design” refers to a process in which attributes, workflows, or offerings of a service are designed, evaluated, or modified, at least in part, based on information processed by the system.

The term “provision conditions” refers to parameters that govern how a product or service is offered, such as pricing, bundling, access method, or eligibility conditions, which may be adjusted based on characteristics of the target user image and reaction information.

In one embodiment, a server cooperates with at least one terminal operated by a user to implement the claimed system. The server comprises at least one processor, a memory, and at least one communication interface connected to a communication network. The terminal comprises at least one processor, a display device, one or more input devices, and optionally a camera and a microphone.

The server stores, in the memory, a plurality of software modules including: a communication control module, a user-input interpretation module, a behavior-history management module, an emotion analysis module, a prompt-generation module, a generative-model interface module, a candidate-mapping module, a ranking module, a link-generation module, and a persona-generation and analytics module. The server also stores a data repository including at least one information collection consisting of item records, and at least one log repository storing behavior history information, selection history, and acquisition procedure completion history.

The terminal executes an application or browser script that communicates with the server and presents user interfaces. The terminal displays an input field for free-text entry, such as “Enter a hobby you want to start” or “Describe your target customer.” The user inputs text such as “I want to start fishing as a hobby” or “The target for the new skincare product is women in their 30s who want environmentally friendly products.” The terminal converts this text into a structured request including at least a user identifier and the input text, and transmits the request to the server through the communication interface.

The server uses the user-input interpretation module to parse incoming text. In one embodiment, the server executes a natural language processing library on a general-purpose processor. The server tokenizes the text, applies part-of-speech tagging, and performs named-entity recognition to extract candidate hobby terms, product categories, age ranges, and other attributes. The server represents extracted elements in a structured data record, for example as key-value pairs such as “hobby=fishing”, “level=beginner”, “target_age_group=thirties”, and the like. The server stores this structured representation in memory as part of a request context.

The server uses the behavior-history management module to retrieve behavior history information from the log repository and from a transaction database. The server maintains, in the memory or in a database table, behavior history entries each including a user identifier, an item identifier, a timestamp, an action type (view, click, purchase, completion), and auxiliary attributes such as device type or session identifier. The server aggregates these entries into behavior features, such as counts of actions per item category, recency of last action per category, and conversion ratios. The server stores numerical feature vectors in the request context, each feature vector including entries such as “sports_items_purchase_count=12” or “beginner_level_items_click_rate=0.7”.

The server uses the emotion analysis module to compute an emotion state from emotion-related information. In one embodiment, the server processes only text; in another embodiment, the server additionally processes voice and facial expression data transmitted from the terminal. The server computes text-based emotion by applying a classifier to the token sequence. For example, the server may use a neural network classifier with an embedding layer, one or more recurrent or transformer layers, and a softmax output layer producing probabilities for classes such as “joy”, “excitement”, “anticipation”, and “anxiety”. The server feeds the user's text as a sequence of word identifiers into the model, computes intermediate hidden states, and obtains a probability distribution over emotion labels. The server selects the emotion state with the highest probability and attaches the corresponding label and probability score to the request context.

When the terminal transmits image or audio data, the server optionally executes an additional emotion classifier or uses a separate emotion analysis service. The server extracts facial landmarks or spectral features (for example, mel-frequency cepstral coefficients) and feeds them into another neural network model for emotion recognition. The server then combines text-based and media-based probabilities, for example by weighted averaging or by a small fusion network, to produce a final emotion state. This multi-modal processing enables the server to obtain a more accurate and robust emotion classification than a purely text-based approach.

The server uses the prompt-generation module to construct a prompt sentence to be input to a generative information processing model, referred to herein as a generative AI model. The server selects a prompt template based on an identified use case. For example, when the user input relates to starting a hobby, the server selects a template for hobby item recommendation. When the input relates to a target customer for product development, the server selects a persona-generation template.

The server fills placeholders in a selected template with structured attributes from the request context, including the interest object, behavior history features, and emotion state. For example, the server may generate a prompt sentence such as:

“The user says: ‘I want to start fishing as a hobby.’ Emotion: ‘excitement’. Generate a list of essential items for a beginner in fishing that will enhance their excitement. Output 10 items.”

In another example, the server may generate a prompt sentence such as:

“The user wants to start golf as a hobby. The user feels ‘excitement’ and often buys sports products. Recommend a prioritized list of golf products and services (equipment, lessons, course reservations) for an excited beginner.”

In a further example, the server may generate a prompt sentence such as:

“Generate a detailed persona of a woman in her 30s who is highly environmentally conscious and is looking for eco-friendly skincare products. Describe her lifestyle, purchase behavior, preferred channels, and sensitivity to price.”

The server constructs the prompt sentence deterministically from structured features, rather than simply reusing raw user text. This structured prompt generation enables the generative AI model to receive well-formed, context-rich instructions that encode machine-computed behavior and emotion features, improving alignment between the model output and downstream retrieval.

The server uses the generative-model interface module to send the prompt sentence to a generative AI model. In one embodiment, the server accesses an external generative model service through an application programming interface. The server transmits the prompt sentence, model selection parameters, and generation parameters such as maximum output length, temperature, and top-k or top-p sampling controls. The generative AI model may be implemented as a transformer-based neural network with multiple attention layers, layer-normalization units, and feed-forward sub-layers. The model uses a learned vocabulary to tokenize the prompt sentence, computes context-dependent embeddings, and iteratively predicts output tokens according to probability distributions produced by the network.

In another embodiment, the server executes a generative model locally using a machine learning framework. The server stores trained model parameters in the memory or in a storage device, and the processor loads parameter tensors into memory. The processor performs matrix multiplications and non-linear activation functions to propagate activations through multiple transformer layers. The model may be trained using a loss function such as cross-entropy over next-token predictions, with gradient-based updates such as stochastic gradient descent with adaptive learning rate. The server can fine-tune model parameters on domain-specific text, such as historical prompts and desired outputs, to improve domain performance.

The server receives, as candidate information, the textual output produced by the generative AI model. The server uses the candidate-mapping module to convert abstract items in the candidate information into concrete items in the information collection. The server first parses the textual output into a list of abstract item descriptions, for example by splitting the output on line breaks or number markers. The server then extracts key terms from each abstract item, such as “beginner fishing rod”, “fishing line”, “bait”, “golf lesson package”, or “eco-friendly moisturizer”. The server uses a combination of lexical matching and embedding-based similarity search to identify candidate concrete items in the information collection.

In one embodiment, the server maintains, in the memory, a vector index of item records in the information collection. The server pre-computes an embedding vector for each item description using a neural encoder. When the server receives an abstract item phrase, the server computes an embedding vector for the phrase and performs a nearest-neighbor search in the vector index to retrieve one or more concrete items with high similarity. The server may also apply symbolic filters using category and attribute fields, such as restricting results to a particular hobby or price range. This combination of generative output parsing and vector-based mapping reduces ambiguity and improves matching accuracy compared to keyword-only retrieval.

The server uses the ranking module to assign scores to concrete items based on the emotion state, behavior history features, and additional parameters such as item popularity and review scores. The server defines a scoring function S(item) that combines multiple components. For example, the server may compute:

$$S ( item ) = w 1 \times G ( item ) + w 2 \times H ( item ) + w 3 \times E ( item ) + w 4 \times P ( item ) ,$$

where G(item) is an alignment score derived from the generative output (for example, similarity between the item's description and the abstract recommendation phrase), H(item) is a behavior-history compatibility score, E(item) is an emotion compatibility score (for example, whether the item is experiential and thus suitable for “excitement”), and P(item) is a popularity or quality score derived from historical performance or rating data. The weights w1, w2, w3, and w4 are parameters that the server can adjust based on offline optimization or online feedback.

The server ranks concrete items based on S(item) in descending order and selects a group of items for presentation. By incorporating emotion state and behavior history into the scoring function, the server reduces the number of irrelevant items, decreases the need for repeated retrieval and re-ranking, and improves both recommendation precision and computational efficiency.

The server uses the link-generation module to create connection information for each concrete item in the group of items. The server constructs a network address for a resource associated with the item, such as a detail page or an acquisition procedure screen. The server may generate a uniform resource locator incorporating an item identifier and tracking parameters representing the context, such as the emotion state or prompt identifier. In the case of a native application, the server may generate a deep link with a scheme identifier and a path pointing to the in-app item screen. The server stores the connection information in the group of items and transmits the group and the connection information to the terminal.

The terminal receives the group of items and connection information, and displays them on the display device. The terminal renders item images, titles, prices, and explanatory text. The terminal may also visually emphasize items that are especially aligned with the detected emotion state, such as adding an indicator “Recommended for excited beginners.” When the user selects an item, the terminal opens the resource referenced by the connection information, such as a purchase page or registration screen.

The server uses the persona-generation and analytics module to generate target user images for product development or service design. The server interprets planner input describing a target segment, constructs a dedicated prompt sentence from extracted attributes, and transmits this prompt sentence to the generative AI model. The server obtains, as model output, a persona description including attributes such as age, interests, decision criteria, and price sensitivity. The server stores target user images in a repository, associating them with market research information and performance metrics from live interactions.

The server uses behavior history information, selection history, and acquisition procedure completion history to adapt prompt sentence structures and ranking parameters over time. The server aggregates, for each prompt template or parameter setting, performance measures such as click-through rate, conversion rate, and dwell time. The server then updates weights in the scoring function, threshold values used in mapping, or token sequences used in certain prompt templates. The server can implement this adaptation as a reinforcement-learning-like process, adjusting parameters to maximize a utility function such as expected conversion rate, while enforcing constraints on latency and resource consumption.

This integrated pipeline provides technical improvements over conventional architectures. The server reduces redundant data transfers by generating prompt sentences that already encode specific preferences and emotion features, allowing the generative AI model to produce narrow, high-relevance outputs and reducing the volume of candidate items that must be fetched and processed. The server decreases computation in downstream modules by using a combined similarity and vector-index mapping to concrete items, avoiding repeated full-text searches of the information collection. The server improves latency and throughput by representing behavior history and emotion state as compact feature vectors that can be reused across sessions and cached in memory.

The server improves the accuracy and stability of generative outputs by using structured prompt generation and by feeding back interaction performance into prompt template selection and parameter tuning. This creates a non-conventional loop in which the generative AI model is not used as a static text producer, but as a component integrated with a feature-based ranking engine and a vector-indexed data store. The server achieves lower error rates in item mapping and ranking by combining model outputs with domain-specific constraints encoded in the scoring function and mapping rules, which are not easily replicated by manual human procedures.

The server also contributes to technical improvements in data management. By storing structured representations of prompts, feature vectors, mapping results, and ranking scores, the server enables systematic auditing and replay of recommendation decisions. The server can reconstruct the state of the pipeline for a given interaction, including the prompt sentence, generative output, mapping operations, and parameter values. This structured data allows more efficient debugging and optimization and permits batch processing and model retraining using logged interactions.

In further embodiments, the server can adopt alternative architectures while implementing the same general functions. For example, the generative AI model can be replaced with a different type of generative model, such as a sequence-to-sequence recurrent architecture. The emotion analysis module can be implemented using a support vector machine with hand-crafted features instead of a neural classifier. The vector index for mapping can employ different approximate nearest-neighbor algorithms. The ranking module can include additional features such as network latency or device type to pre-filter items that would cause slow rendering on certain terminals. In each variation, the server maintains the central concept of generating prompt sentences from structured features, obtaining candidate information from a generative model, mapping abstract items to concrete records, and ranking and presenting them with feedback-driven parameter adjustments.

The server can also support different usage scenarios beyond hobby recommendation and product development. For instance, the same architecture may be applied to service bundle configuration, training content recommendation, or resource allocation in technical support systems, where the “items” are services, documents, or workflows. In each case, the server uses the same technical components-structured prompt generation, generative model interaction, mapping, ranking, and feedback tuning-to improve computational efficiency, response time, and output quality in a manner that goes beyond merely automating a human decision process.

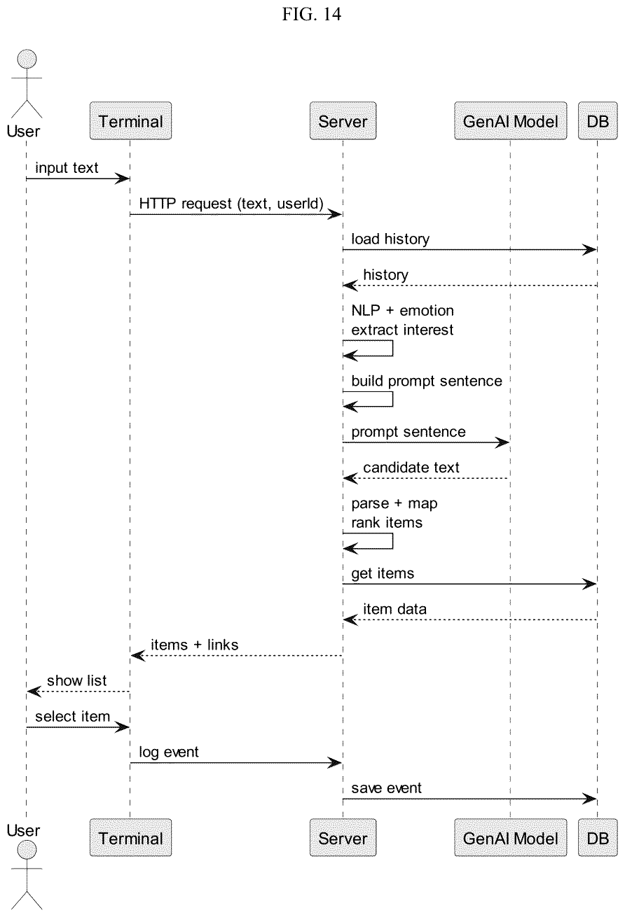

The following describes the processing flow using FIG. 14.

### Step 1

The user operates the terminal and inputs free-text information. The user types, for example, “I want to start fishing as a hobby,” “I want to start golf as a hobby, I am really excited,” or “The target for the new skincare product is women in their 30s who want environmentally friendly products.” The terminal receives this text as input together with a user identifier stored in the terminal. The terminal converts the text and the user identifier into a structured request object, sets HTTP headers, and outputs an HTTP request payload that includes at least ‘{user_id, text}’ toward the server.

### Step 2

The server receives the HTTP request from the terminal. The server treats the HTTP request as input and parses the request line, headers, and body using a communication control module. The server validates the content type, checks the existence and basic format of the user identifier and text, and rejects malformed input. The server writes a log entry including timestamp, user identifier, and raw text into a persistent log store. The server outputs a validated request context held in memory, containing the user identifier and the input text as structured fields.

### Step 3

The server retrieves behavior history information for the user. The server uses the user identifier in the request context as input and issues a query to a transaction and log database. The server executes data retrieval operations to obtain records including fields such as ‘{user_id, item_id, timestamp, action_type, category, price}’. The server aggregates these records with a behavior-history management module: it counts actions per category, computes recency values, and calculates conversion ratios. The server outputs a behavior feature vector, for example ‘{sports_purchase_count=8, beginner_item_click_rate=0.65, average_price=50}’, and attaches this vector to the request context.

### Step 4

The server analyzes the emotion state of the user based on text. The server uses the input text from the request context as input to an emotion analysis module. The server tokenizes the text, converts tokens to numerical identifiers, and feeds the token sequence into a pre-trained neural classifier with an embedding layer, multiple hidden layers, and a softmax output layer over emotion classes. The server performs matrix multiplications and non-linear activation functions to compute class probabilities. The server outputs an emotion label, such as “excitement,” “joy,” or “anticipation,” and a probability score, such as 0.85, and stores the emotion label and score in the request context.

### Step 5

The terminal optionally captures additional emotion-related information such as facial expression or voice. The user speaks a phrase or looks at the camera while interacting with the terminal. The terminal records a short video or audio segment and treats this signal as input. The terminal compresses the signal, adds metadata such as frame rate or sampling frequency, and outputs a media attachment in a secondary HTTP request to the server.

### Step 6

The server receives media data from the terminal and performs multi-modal emotion refinement. The server uses the audio or video stream as input to a media-based emotion analysis module. The server extracts feature vectors, such as facial landmarks for each frame or mel-frequency cepstral coefficients for audio frames, by applying digital signal processing algorithms. The server feeds these feature vectors into a neural network model for emotion recognition and computes probabilities for the same or compatible emotion classes. The server combines text-based emotion probabilities and media-based emotion probabilities, for example by weighted averaging, and outputs a refined emotion state and score, which overwrite or augment the previous emotion label in the request context.

### Step 7

The server identifies an interest object and other attributes from the user text. The server uses the raw text from the request context as input to a user-input interpretation module. The server runs natural language processing operations including tokenization, part-of-speech tagging, and named-entity recognition. The server detects candidate entities such as “fishing,” “golf,” “gardening,” “photography,” or “skincare,” and identifies modifiers such as “beginner,” “new,” or “environmentally friendly.” The server maps these entities and modifiers to standardized categories and attribute codes using a mapping table. The server outputs structured attributes, for example ‘{interest_object=HOBBY_FISHING, level=BEGINNER}’ or ‘{interest_object=SKINCARE, target_age_group=THIRTIES, eco_preference=HIGH}’, and stores them in the request context.

### Step 8

The server generates a prompt sentence for a generative AI model. The server uses the structured attributes, the behavior feature vector, and the emotion state in the request context as input to a prompt-generation module. The server selects a prompt template based on the interest object type, such as a hobby-recommendation template or a persona-generation template. The server fills placeholders in the template with concrete values, concatenates strings, and ensures that the resulting text describes the user's situation in natural language. The server outputs a prompt sentence such as “The user says: ‘I want to start fishing as a hobby.’ Emotion: ‘excitement’. Generate a list of essential items for a beginner in fishing that will enhance their excitement. Output 10 items.” or “Generate a detailed persona of a woman in her 30s who is highly environmentally conscious and is looking for eco-friendly skincare products. Describe her lifestyle, purchase behavior, preferred channels, and sensitivity to price.” The server stores the prompt sentence in the request context and in an audit log.

### Step 9

The server invokes a generative AI model using the prompt sentence. The server uses the prompt sentence and model parameters (maximum length, temperature, sampling configuration) as input to a generative-model interface module. The server calls a generative information processing model through a model execution interface, sending the prompt sentence as part of the request payload. The generative AI model, implemented for example as a transformer network, processes the input tokens and generates output tokens that form text. The server receives the generated text as candidate information and associates it with the current request context. The server outputs the candidate information, which contains descriptions of items or a persona, such as a list of fishing essentials or a persona narrative.

### Step 10

The server parses the candidate information into abstract items. The server uses the generated text from the generative AI model as input to a candidate-mapping module. The server splits the text into individual lines or segments, for example at line breaks or numbered list markers. For each segment, the server extracts key phrases, such as “beginner fishing rod,” “fishing line,” “bait,” “golf lesson for beginners,” or “eco-friendly facial cleanser.” The server represents each abstract description as a structured record including at least a label string and optional inferred category. The server outputs a list of abstract item records ready for mapping to concrete items.

### Step 11

The server maps abstract items to concrete items in an information collection. The server uses the list of abstract item records and the information collection as input to the mapping logic. The server computes an embedding vector for each abstract item description by applying a text encoder, and retrieves pre-computed embedding vectors for item descriptions in the information collection. The server performs similarity computation, such as cosine similarity, between each abstract item vector and candidate item vectors, and identifies top matches. The server may also filter candidates using symbolic constraints such as category, price range, or availability. The server outputs, for each abstract item, one or more concrete items with identifiers and metadata, forming a preliminary mapped item list.

### Step 12

The server computes ranking scores for the concrete items. The server uses the mapped item list, the behavior feature vector, the emotion state, and additional item attributes such as popularity and rating as input to the ranking module. The server evaluates a scoring function for each item, combining components such as generative alignment, behavior compatibility, emotion compatibility, and popularity with predetermined or dynamically adjusted weights. The server performs arithmetic operations to compute a numerical score for each item, sorts items by descending score, and selects a group of items up to a configured maximum size. The server outputs this ranked group of items and attaches ranking scores to each item record.

### Step 13

The server generates connection information to acquisition procedure screens. The server uses the ranked group of items as input to the link-generation module. For each item, the server constructs a network address or deep link by concatenating a base path and the item identifier, and by appending query parameters such as campaign identifiers or emotion identifiers. The server creates a connection field for each item record, containing the generated address. The server outputs an enriched group of items, each including at least ‘{item_id, title, price, description, rank_score, connection_information}’.

### Step 14

The server constructs a response payload and sends it to the terminal. The server uses the enriched group of items, the interest object, and the emotion state as input to a response construction module. The server encodes the data into a structured response format, sets a success status, and routes the response through the communication control module to the terminal. The server outputs an HTTP response containing the group of items, connection information, and contextual fields such as the recognized interest and emotion.

### Step 15

The terminal receives the response and renders the group of items. The terminal uses the HTTP response from the server as input. The terminal parses the structured data to obtain item fields and connection information, and creates view objects for display. The terminal draws images, titles, prices, and the short reasons or descriptions on the display and may highlight items with tags such as “Recommended for excited beginners.” The terminal outputs a graphical user interface that visually presents the ranked group of items and interactive controls such as buttons to view details or start an acquisition procedure.

### Step 16

The user interacts with the presented items and initiates acquisition procedures. The user views the list of items, scrolls, and selects one or more items by tapping or clicking item entries or buttons. The terminal receives these interaction events as input and extracts the corresponding connection information for each selected item. The terminal uses the connection information to open a detail page or acquisition procedure screen in a browser view or within an application component. The terminal outputs a transition to a resource where the user can review full item information and proceed with a checkout or registration.

### Step 17

The server logs selection history and acquisition procedure completion history. The terminal transmits interaction events and transaction results as input to the server, including fields such as ‘{user_id, item_id, event_type, timestamp}’. The server records these events in a log repository as new behavior history entries. The server updates cumulative counters and derived statistics in the behavior-history management module, such as item-level click counts and conversion rates. The server outputs updated behavior feature tables and uses them for subsequent requests from the same or similar users.

### Step 18

The server generates and updates target user images for product or service development. The server uses planner input text, behavior statistics, and optionally market research information as input to the persona-generation and analytics module. The server interprets planner descriptions such as “The target for the new skincare product is women in their 30s who want environmentally friendly products,” constructs a prompt sentence using extracted attributes, and invokes the generative AI model. The server receives a persona description in text form as output, stores it as a target user image record, and compares characteristics of this target user image with aggregated market data. The server further uses observed selection and acquisition histories for users mapped to similar attributes to refine prompt templates and scoring weights, and outputs updated templates and parameters to be used in future prompt-generation and ranking operations.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

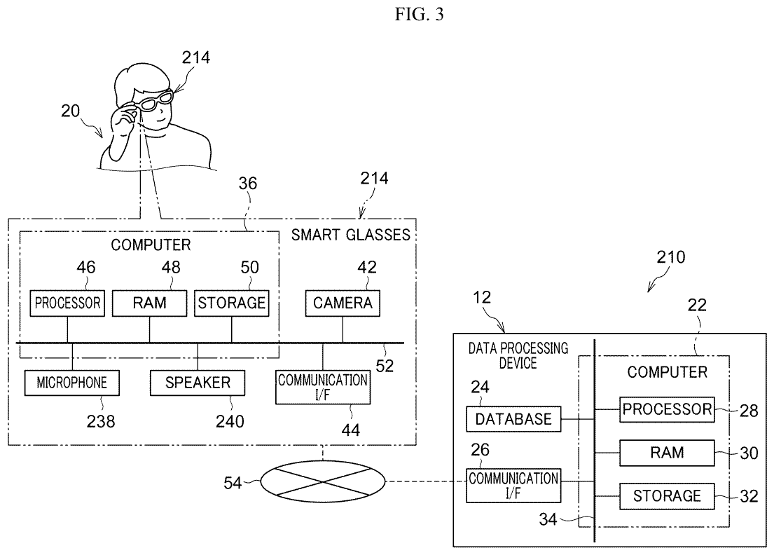

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

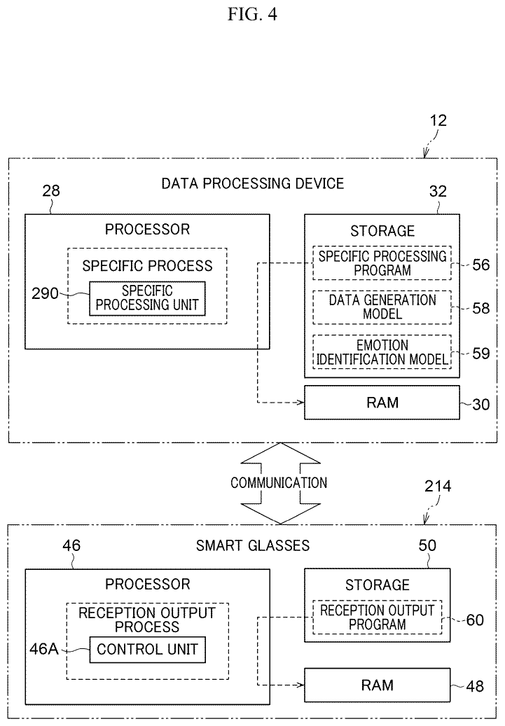

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

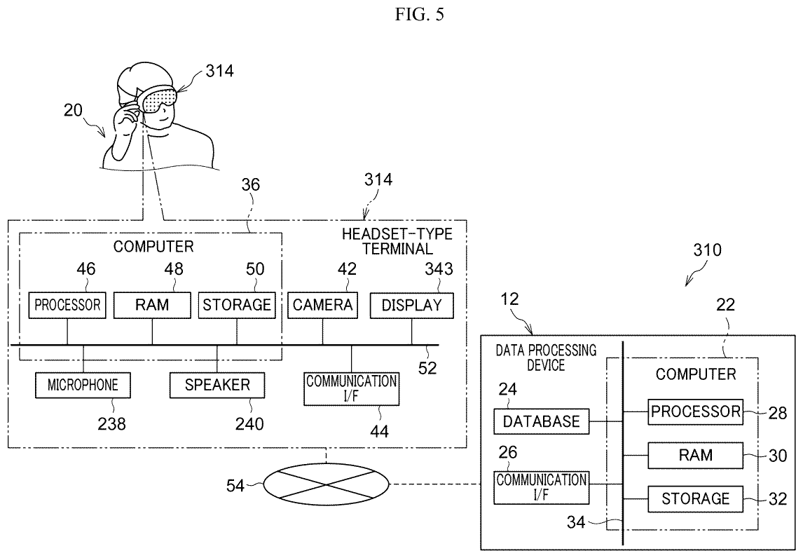

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

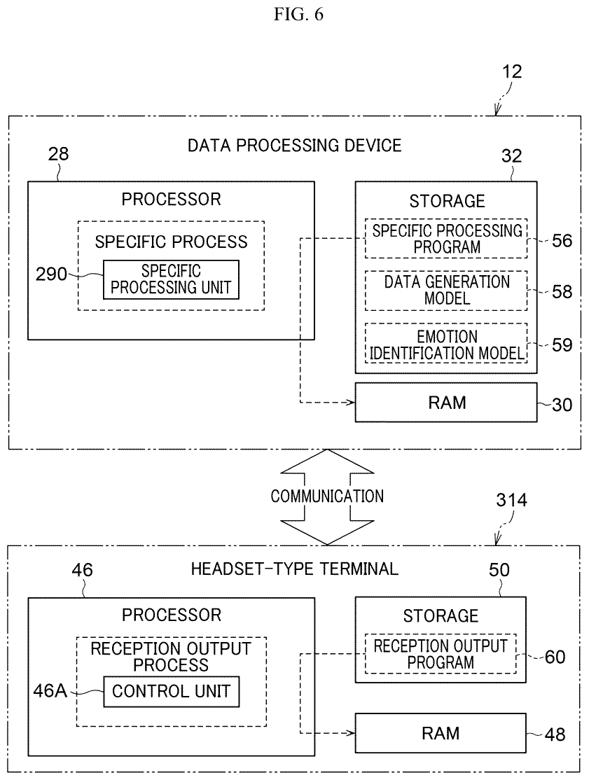

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

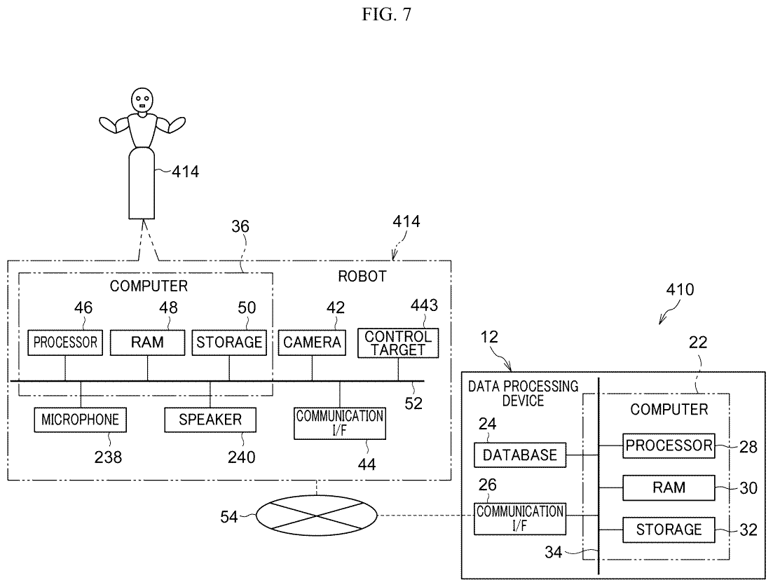

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

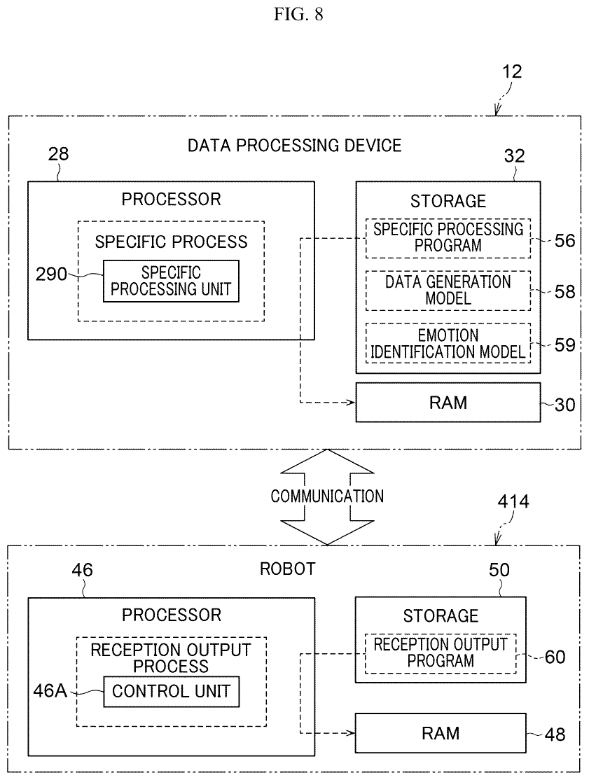

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

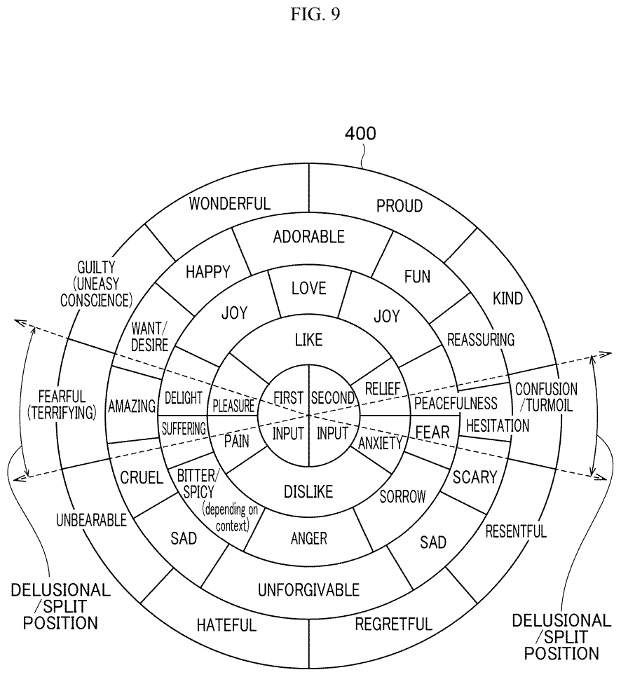

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

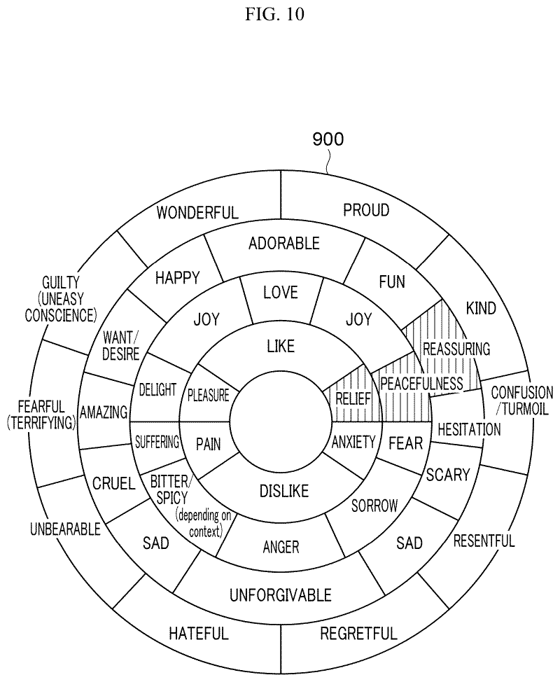

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
receive input information related to a hobby from a user, analyze the input information, and extract a user profile and requirement information related to the hobby from the input information,
generate a prompt sentence for causing a generative AI model to generate the user profile based on the extracted user profile and requirement information, and input the prompt sentence to the generative AI model to cause the generative AI model to generate a virtual person corresponding to the user profile,
generate search information for extracting candidate product groups required for an activity related to the hobby by using the input information and information of the virtual person obtained from the generative AI model, acquire the candidate product groups from an information storage apparatus by using the search information, and generate list information of the candidate product groups,
transmit the generated list information of the candidate product groups to a user terminal and cause the list information to be displayed on the user terminal, and
present purchase information of each product included in the list information in a selectable state at the user terminal, and, for a selected product, provide a purchase processing screen or connection information to an external apparatus.

### Supplementary 2

The system according to supplementary 1,
wherein the processor is configured to
compare the requirement information related to the hobby, obtained by the generation of the prompt sentence and the generation of the virtual person, with market trend information or survey information, and evaluate a depth and diversity of requirements that are difficult to grasp by a general survey method.

### Supplementary 3

The system according to supplementary 1,
wherein the processor is configured to
adjust a product configuration or a product specification for the activity related to the hobby based on characteristics of the virtual person and the list information of the candidate product groups, and support new product planning or product design.

### Application Example 1

### Supplementary 1

A system comprising a processor,
wherein the processor is configured to
receive, from a user terminal, input information related to a user's hobby or leisure activity, analyze the input information, and generate a prompt sentence that instructs a generative AI model to enumerate a group of articles necessary for starting the hobby or leisure activity,
input the generated prompt sentence into the generative AI model and, by using the generative AI model, generate article list information including a plurality of articles related to the hobby or leisure activity,
convert the generated article list information into structured data, and for each article, assign an identifier, description information, and acquisition-source information to generate output data, and
transmit the output data to a mobile information terminal via a communication line so that the mobile information terminal visually presents the output data to a user.

### Supplementary 2

The system according to supplementary 1,
wherein the processor is configured to
refer to a merchandise information storage device or an external merchandise information providing device for each article included in the generated article list information, acquire price information, image information, and purchase-link information, and add the acquired information to the output data.

### Supplementary 3

The system according to supplementary 1,
wherein the processor is configured to
dynamically modify at least one of a wording format of the prompt sentence, an output format of the article list information, and an upper limit on a number of articles, based on at least one of content of the input information related to the user's hobby, user attribute information, and preset condition information, thereby adjusting instruction content to be given to the generative AI model.

### Example 2

### Supplementary 1

A system comprising a processor,
wherein the processor is configured to
receive instruction information from a user, analyze the instruction information, generate a prompt sentence for a generative AI model, and instruct the generative AI model to generate a virtual user profile based on the prompt sentence,
input the prompt sentence into the generative AI model, cause the generative AI model to generate the virtual user profile, and further cause the generative AI model to generate product-related information associated with the virtual user profile based on the instruction information,
analyze the product-related information obtained from the generative AI model and
normalize the product-related information into structured information including, for each product information item, at least a product name, price information, description information, image identification information, and purchase connection information,
generate user interface display data for providing product information based on the structured information and transmit the user interface display data to a terminal device so that the terminal device presents, on a display, visual elements including at least the product name, the price information, the description information, and the image identification information,
receive, from the terminal device, request information corresponding to selection of the purchase connection information or a selection operation of a product information item, and execute a connection process to a purchase information processing device based on the purchase connection information or a connection process to a purchase screen corresponding to the product information item in response to the request information, and
compare the virtual user profile and the product-related information with at least one of product planning information, design information, and market analysis information, and use results of the comparison for generating a new viewpoint or opinion in product development.

### Supplementary 2

The system according to supplementary 1,
wherein the processor is configured to
compare characteristic information of the virtual user profile and the product-related information with external information including at least one of market research information, sales information, and user attribute information, and correct or expand the structured information based on a comparison result so as to generate product information having depth and breadth that are not obtainable by general market research.

### Supplementary 3

The system according to supplementary 1,
wherein the processor is configured to
generate product design support information for adjusting at least one of product specification information, function configuration information, and price setting information based on characteristic information of the virtual user profile and the product information items included in the structured information, and present the product design support information via a user interface so as to support product development in accordance with market needs.

### Application Example 2

### Supplementary 1

A system comprising a processor,
wherein the processor is configured to
receive and interpret information from a user,
acquire preference-related information and behavior history information of the user and analyze the information to specify an interest object of the user,
acquire emotion-related information of the user based on an utterance or an expression of the user and specify an emotion state of the user,
generate a prompt sentence to be input to a generative information processing model on the basis of the interest object, the behavior history information, and the emotion state,
input the prompt sentence to the generative information processing model and generate candidate information related to the interest object by using the generative information processing model,
map abstract items included in the candidate information to concrete items obtained from an information collection,
rank the concrete items on the basis of the emotion state and the behavior history information and generate a group of items to be presented,
generate connection information to an acquisition procedure screen for each item in the group of items and present the group of items together with the connection information to a terminal of the user, and
analyze input information from the user, generate a prompt sentence for instructing the generative information processing model to generate a target user image, generate the target user image by using the generative information processing model, and utilize the target user image as a viewpoint and an opinion provider for product development or service design.

### Supplementary 2

The system according to supplementary 1,
wherein the processor is configured to
collect selection history and acquisition procedure completion history with respect to the group of items, adjust a structure of the prompt sentence and conditions for the ranking on the basis of the history, and compare market research information with characteristics of the target user image so as to provide depth and breadth of information that are not obtainable by a general research method.

### Supplementary 3

The system according to supplementary 1,
wherein the processor is configured to
change specifications and provision conditions of a product or a service on the basis of characteristics of the target user image and reaction information of the user to the group of items, and support product development or service design adapted to market demand.

What is claimed is:

1. A system comprising:
circuitry configured to:
receive, via a communication interface coupled to a packet-switched network, input data from a terminal device;
analyze the input data to extract attribute information;
generate a prompt sentence for instructing a generative neural network model to generate profile data, the prompt sentence being based on the attribute information;
input the prompt sentence into the generative neural network model and acquire the profile data from the generative neural network model;
derive output data from the profile data; and
transmit the output data to the terminal device via the communication interface.

2. The system according to claim 1, wherein the circuitry is further configured to tokenize the input data into a sequence of tokens and compute feature vectors from the sequence of tokens using a text embedding model.

3. The system according to claim 2, wherein the circuitry is further configured to construct the prompt sentence by inserting the attribute information and the feature vectors into a prompt template stored in a storage device coupled to the circuitry.

4. The system according to claim 3, wherein the generative neural network model comprises a transformer-based language model, and wherein the circuitry is further configured to set inference parameters including a temperature value and a maximum output length before inputting the prompt sentence into the generative neural network model.

5. The system according to claim 4, wherein the profile data comprises a virtual person representation including at least an age range, an experience level, a set of preference attributes, and a set of inferred requirement attributes generated by the transformer-based language model.

6. The system according to claim 1, wherein the circuitry is further configured to generate search parameters by combining the attribute information extracted from the input data with attribute values extracted from the profile data, and retrieve, from a storage device, a set of data records matching the search parameters.

7. The system according to claim 6, wherein the circuitry is further configured to compute a relevance score for each data record in the set of data records based on a similarity between the attribute values of the profile data and attributes of each data record, and rank the set of data records according to the relevance scores.

8. The system according to claim 7, wherein the output data comprises list information of the ranked set of data records together with connection information for each data record, the connection information comprising a network address for accessing a detail resource associated with each data record.

9. The system according to claim 1, wherein the circuitry is further configured to acquire behavior history information associated with an identifier of the terminal device from a log repository, and incorporate the behavior history information into the prompt sentence.

10. The system according to claim 9, wherein the circuitry is further configured to perform emotion analysis on the input data by inputting the input data into an emotion identification model to determine an emotion state, and further incorporate the emotion state into the prompt sentence.

11. The system according to claim 10, wherein the emotion identification model receives multi-modal input comprising at least one of audio data captured by a microphone of the terminal device and image data captured by a camera of the terminal device, and wherein the circuitry computes an emotion feature vector from the multi-modal input using a convolutional neural network.

12. The system according to claim 1, wherein the circuitry is further configured to parse a text output of the generative neural network model into a plurality of structured segments, and map each structured segment to a corresponding field of the profile data.

13. The system according to claim 12, wherein the circuitry is further configured to normalize the plurality of structured segments by applying deduplication processing and string normalization, and compute embedding vectors for each structured segment using a text encoder model.

14. The system according to claim 1, wherein the input data comprises a text string describing an activity that a user of the terminal device wishes to pursue, and wherein the attribute information includes at least one of an activity domain, a skill level, a constraint parameter, and a purpose parameter extracted from the text string.

15. The system according to claim 14, wherein the circuitry is further configured to compare characteristics of the profile data with market trend information stored in the storage device and generate comparison result data indicating a similarity or a difference between the characteristics and the market trend information.

16. The system according to claim 15, wherein the circuitry is further configured to adjust a configuration of the output data based on the characteristics of the profile data and the comparison result data to align the output data with requirements derived from the market trend information.

17. The system according to claim 1, wherein the circuitry is further configured to log interaction events received from the terminal device in a log repository, the interaction events including selection data and transaction completion data, and update inference parameters of the generative neural network model or ranking weights based on the logged interaction events.

18. A system comprising:
circuitry configured to:
receive, via a communication interface coupled to a packet-switched network, input data in text form from a terminal device, the input data describing an interest of a user of the terminal device;
perform natural language processing on the input data to tokenize the input data into a sequence of tokens and extract attribute information including an interest domain and a skill level;
construct a prompt sentence by inserting the attribute information into a prompt template, the prompt sentence comprising an instruction for a transformer-based generative neural network model to generate a virtual person representation;
transmit the prompt sentence to the transformer-based generative neural network model and acquire the virtual person representation from the transformer-based generative neural network model, the virtual person representation comprising at least a set of preference attributes and a set of inferred requirement attributes;
generate search parameters by combining the attribute information with the preference attributes and the inferred requirement attributes of the virtual person representation;
retrieve, from a storage device, a set of data records matching the search parameters and rank the set of data records based on a relevance score computed from a similarity between the virtual person representation and attributes of each data record; and
transmit, via the communication interface, list information of the ranked set of data records together with connection information for each data record to the terminal device.

19. The system according to claim 18, wherein the circuitry is further configured to acquire an emotion state of the user by inputting at least one of the input data and multi-modal sensor data received from the terminal device into an emotion identification model, and incorporate the emotion state into the prompt sentence and into the relevance score computation.

20. A method performed by circuitry of a server coupled to a packet-switched network via a communication interface, the method comprising:
receiving, via the communication interface, input data from a terminal device;
analyzing the input data to extract attribute information;
generating a prompt sentence for instructing a generative neural network model to generate profile data, the prompt sentence being based on the attribute information;
inputting the prompt sentence into the generative neural network model and acquiring the profile data from the generative neural network model;
deriving output data from the profile data; and
transmitting the output data to the terminal device via the communication interface.
